(19) United States
(12) Patent Application Publication
(10) Pub. No.: US 2026/0330185 A1
(43) Pub. Date: Oct. 22, 2026

(54) INFORMATION PROCESSING APPARATUS, INFORMATION PROCESSING METHOD, AND PROGRAM

(71) Applicant: NTT, Inc., Tokyo (JP)

(72) Inventors: Yoshiaki TAKIMOTO, Musashino-shi (JP); Maya OKAWA, Musashino-shi (JP); Tomoharu IWATA, Musashino-shi (JP); Yusuke TANAKA, Musashino-shi (JP); Hideaki KIN, Musashino-shi (JP)

(73) Assignee: NTT, Inc., Tokyo (JP)

(21) Appl. No.: 19/110,448

(22) PCT Filed: Sep. 13, 2022
(86) PCT No.: PCT/JP2022/034271

§ 371 Date: Mar. 11, 2025

(51) Int. Cl. G06N 3/045

(52) U.S. Cl. CPC G06N 3/045

(57) ABSTRACT

An information processing apparatus according to an embodiment includes: a first monotonic neural network; a second monotonic neural network; a first calculation unit that calculates a first cumulative function on the basis of an output from the first monotonic neural network and a parameter; and a second calculation unit that calculates a second cumulative function on the basis of an output from the second monotonic neural network, a parameter, and a period.

### TECHNICAL FIELD

Embodiments of the present invention relate to an information processing apparatus, an information processing method, and a program.

### BACKGROUND ART

A method using a point process is known as one of methods for predicting occurrence of various events such as device failure, human behavior, crime, earthquake, and infectious disease. The point process is a probability model that describes a timing of occurrence of an event.

A neural network (NN) is known as a technique capable of modeling a point process at high speed and with high accuracy. A monotonic neural network (MNN) has been proposed as one of neural networks.

### CITATION LIST

### Non Patent Literature

Non Patent Literature 1: Takahiro Omi, et al., “Fully Neural Network based Model for General Temporal Point Processes,” 33rd Conference on Neural Information Processing Systems (NeurIPS 2019), Vancouver, Canada, <https://arxiv.org/abs/1905.09690>

### SUMMARY OF INVENTION

### Technical Problem

However, the monotonic neural network may be inferior to a normal neural network in terms of expressive power. In addition, the monotonic neural network may lack stability of learning processing due to vanishing or divergence of a gradient of an activation function. The above-described problem of the monotonic neural network becomes particularly noticeable in a case where an event is predicted in a long term.

In addition, it is difficult for the monotonic neural network to incorporate human knowledge, for example, knowledge that an intensity function periodically changes such as days of the week.

The present invention has been made in view of the above circumstances, and an object of the present invention is to provide a means for enabling long-term prediction of an event.

### Solution to Problem

An information processing apparatus of an aspect includes: a first monotonic neural network; a second monotonic neural network; a first calculation unit that calculates a first cumulative function on the basis of an output from the first monotonic neural network and a parameter; and a second calculation unit that calculates a second cumulative function on the basis of an output from the second monotonic neural network, a parameter, and a period.

An information processing method of an aspect is an information processing method performed by an information processing apparatus, and the information processing method includes: outputting, by a first output unit of the information processing apparatus, a scalar value according to a monotonically increasing function from a first monotonic neural network; outputting, by a second output unit of the information processing apparatus, a scalar value according to a monotonically increasing function from a second monotonic neural network; calculating, by a first calculation unit of the information processing apparatus, a first cumulative function on the basis of the scalar value output from the first monotonic neural network and a parameter; and calculating, by a second calculation unit of the information processing apparatus, a second cumulative function on the basis of the scalar value output from the second monotonic neural network, a parameter, and a period.

### Advantageous Effects of Invention

According to embodiments, a means for enabling long-term prediction of an event can be provided.

### BRIEF DESCRIPTION OF DRAWINGS

FIG. 1 is a block diagram illustrating an example of a hardware configuration of an event prediction apparatus according to a first embodiment.

FIG. 2 is a block diagram illustrating an example of a configuration of a learning function of the event prediction apparatus according to the first embodiment.

FIG. 3 is a diagram illustrating an example of a configuration of a sequence in a learning data set of the event prediction apparatus according to the first embodiment.

FIG. 4 is a block diagram illustrating an example of a configuration of a prediction function of the event prediction apparatus according to the first embodiment.

FIG. 5 is a diagram illustrating an example of a configuration of prediction data of the event prediction apparatus according to the first embodiment.

FIG. 6 is a flowchart illustrating an example of learning operation in the event prediction apparatus according to the first embodiment.

FIG. 7 is a flowchart illustrating an example of prediction operation in the event prediction apparatus according to the first embodiment.

FIG. 8 is a block diagram illustrating an example of a configuration of a learning function of an event prediction apparatus according to a second embodiment.

FIG. 9 is a block diagram illustrating an example of a configuration of a prediction function of the event prediction apparatus according to the second embodiment.

FIG. 10 is a flowchart illustrating an example of an outline of learning operation in the event prediction apparatus according to the second embodiment.

FIG. 11 is a flowchart illustrating an example of first update processing in the event prediction apparatus according to the second embodiment.

FIG. 12 is a flowchart illustrating an example of second update processing in the event prediction apparatus according to the second embodiment.

FIG. 13 is a flowchart illustrating an example of prediction operation in the event prediction apparatus according to the second embodiment.

FIG. 14 is a block diagram illustrating an example of a configuration of a latent representation calculation unit of an event prediction apparatus according to a first modification.

FIG. 15 is a block diagram illustrating an example of a configuration of an intensity function calculation unit of an event prediction apparatus according to a second modification.

FIG. 16 is a block diagram illustrating an example of a configuration of a first intensity function calculation unit of an event prediction apparatus according to a third modification.

FIG. 17 is a block diagram illustrating an example of a configuration of a second intensity function calculation unit of the event prediction apparatus according to the third modification.

### DESCRIPTION OF EMBODIMENTS

Hereinafter, some embodiments will be described with reference to the drawings. Note that in the following description, components having the same function and configuration are denoted by common reference signs. In addition, in a case where a plurality of components having a common reference sign is distinguished from each other, the components are distinguished by additional reference signs (for example, hyphens and numbers such as “−1”) attached after the common reference sign.

### 1. First Embodiment

An information processing apparatus according to a first embodiment will be described. Hereinafter, an event prediction apparatus will be described as an example of the information processing apparatus according to the first embodiment.

The event prediction apparatus has a learning function and a prediction function. The learning function is a function of performing meta-learning of a point process. The prediction function is a function of predicting occurrence of an event on the basis of the point process learned by the learning function. The event is an event that occurs discretely on a continuous time. Specifically, for example, the event is a user's purchasing behavior in an electronic commerce (EC) site. The meta learning is a method based on, for example, model-agnostic meta-learning (MAML) or the like, and is disclosed in, for example, a literature “Chelsea Finn, et al., “Model-Agnostic Meta-Learning for Fast Adaptation of Deep Networks,” Proceedings of the 34th International Conference on Machine Learning, Sydney, Australia, PMLR 70:1126-1135, 2017, <https://arxiv.org/abs/1703.03400>”.

### 1.1 Configuration

A configuration will be described of the event prediction apparatus according to the first embodiment.

### 1.1.1 Hardware Configuration

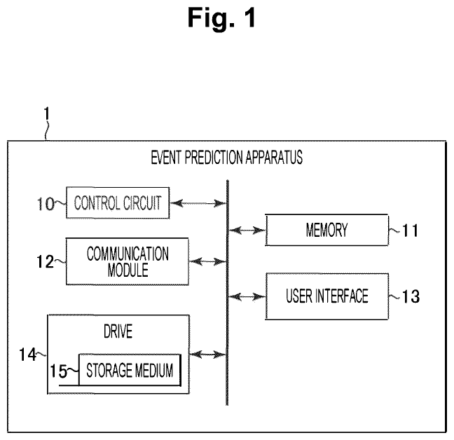

FIG. 1 is a block diagram illustrating an example of a hardware configuration of the event prediction apparatus according to the first embodiment. As illustrated in FIG. 1, an event prediction apparatus 1 includes a control circuit 10, a memory 11, a communication module 12, a user interface 13, and a drive 14.

The control circuit 10 is a circuit that entirely controls components of the event prediction apparatus 1. The control circuit 10 includes a central processing unit (CPU), a random access memory (RAM), a read only memory (ROM), and the like.

The memory 11 is a storage apparatus of the event prediction apparatus 1. The memory 11 includes, for example, a hard disk drive (HDD), a solid state drive (SSD), a memory card, and the like. The memory 11 stores information used for learning operation and prediction operation in the event prediction apparatus 1. In addition, the memory 11 stores a learning program for causing the control circuit 10 to execute the learning operation and a prediction program for causing the control circuit 10 to execute the prediction operation.

The communication module 12 is a circuit used for transmission and reception of data to and from the outside of the event prediction apparatus 1 via a network.

The user interface 13 is a circuit for communicating information between a user and the control circuit 10. The user interface 13 includes an input device and an output device. The input device includes, for example, a touch panel, an operation button, and the like. The output device includes, for example, a liquid crystal display (LCD), an electroluminescence (EL) display, and a printer. The user interface 13 outputs, to the user, a result of executing various programs received from the control circuit 10, for example.

The drive 14 is an apparatus for reading a program stored in a storage medium 15. The drive 14 includes, for example, a compact disk (CD) drive, a digital versatile disk (DVD) drive, and the like.

The storage medium 15 is a medium that accumulates information such as programs by an electrical, magnetic, optical, mechanical, or chemical action. The storage medium 15 may store the learning program and the prediction program.

### 1.1.2 Learning Function Configuration

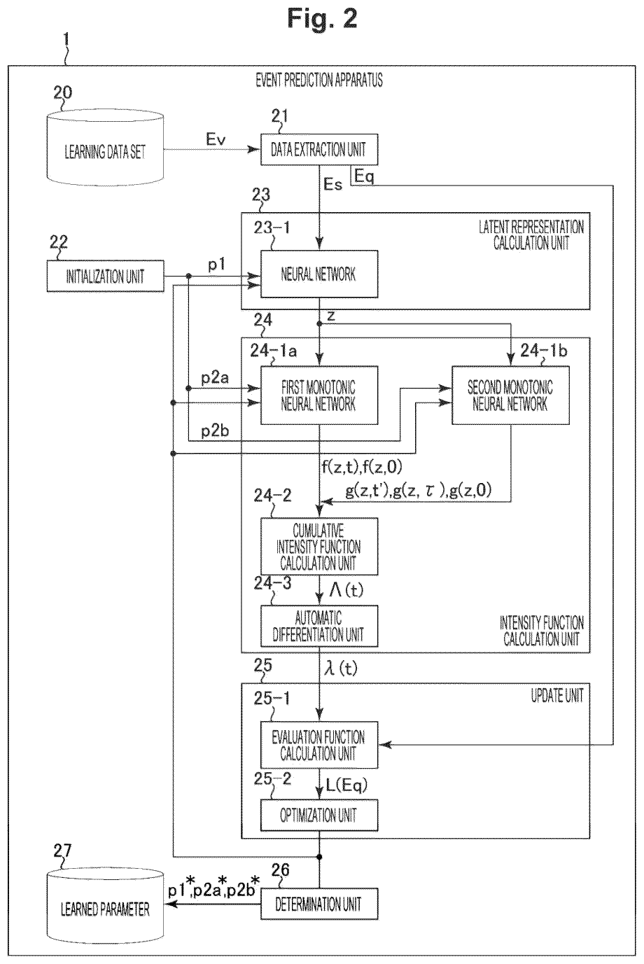

FIG. 2 is a block diagram illustrating an example of a configuration of the learning function of the event prediction apparatus according to the first embodiment.

The CPU of the control circuit 10 deploys the learning program stored in the memory 11 or the storage medium 15 on the RAM. Then, the CPU of the control circuit 10 interprets and executes the learning program deployed on the RAM to control the memory 11, the communication module 12, the user interface 13, the drive 14, and the storage medium 15. As a result, as illustrated in FIG. 2, the event prediction apparatus 1 functions as a computer including a data extraction unit 21, an initialization unit 22, a latent representation calculation unit 23, an intensity function calculation unit 24, an update unit 25, and a determination unit 26. In addition, the memory 11 of the event prediction apparatus 1 stores a learning data set 20 and a learned parameter 27 as information used for the learning operation.

The learning data set 20 is, for example, a set of event sequences of a plurality of users in a certain EC site. Alternatively, the learning data set 20 is, for example, a set of event sequences of a certain user in a plurality of EC sites. The learning data set 20 includes a plurality of sequences Ev. In a case where the learning data set 20 is a set of event sequences of a plurality of users in a certain EC site, each sequence Ev corresponds to, for example, a user.

In a case where the learning data set 20 is a set of event sequences of a certain user in a plurality of EC sites, each sequence Ev corresponds to, for example, an EC site. Each sequence Ev is information including an occurrence time t₁ (1≤i≤I) of I events that has occurred during a period [0, t^{e}] (I is an integer greater than or equal to 1). The numbers of events I in the sequences Ev may be different from each other. That is, a data length of each sequence Ev can take any length.

The data extraction unit 21 extracts the sequence Ev from the learning data set 20. The data extraction unit 21 further extracts a support sequence Es and a query sequence Eq from the extracted sequence Ev. The data extraction unit 21 transmits the support sequence Es and the query sequence Eq to the latent representation calculation unit 23 and the update unit 25, respectively.

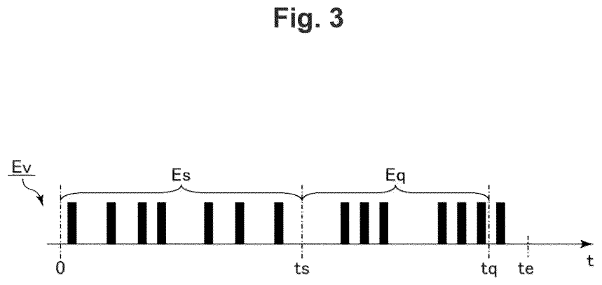

FIG. 3 is a diagram illustrating an example of a configuration of the sequence in a learning data set of the event prediction apparatus according to the first embodiment. As illustrated in FIG. 3, the support sequence Es and the query sequence Eq are partial sequences of the sequence Ev.

The support sequence Es is a partial sequence corresponding to a period [0, tₛ] of the sequence Ev (Es={tᵢ|0≤tᵢ≤tₛ}). The time tₛ is arbitrarily determined within a range greater than or equal to the time 0 and less than the time t^{s}.

The query sequence Eq is a partial sequence corresponding to a period [tₛ, t_{q}] of the sequence Ev (Eq={t₁|tₛ<tᵢ≤tⱼ}). The time t_{q} is arbitrarily determined within a range greater than the time tₛ and less than or equal to the time t^{e}.

Referring again to FIG. 2, a configuration will be described of the learning function of the event prediction apparatus 1.

The initialization unit 22 initializes a plurality of parameters p1, p2a, and p2b on the basis of a rule X. The initialization unit 22 transmits the plurality of initialized parameters p1 to the latent representation calculation unit 23. The initialization unit 22 transmits the plurality of initialized parameters p2a and p2b to the intensity function calculation unit 24. The plurality of parameters p1, p2a, and p2b will be described later.

The rule X includes applying, to a parameter, a random number generated according to a distribution having an average less than or equal to 0. For example, examples of application of the rule X to a neural network having a plurality of layers include initialization of Xavier and initialization of He. In the initialization of Xavier, in a case where the number of nodes in a previous layer is n, parameters are initialized according to a normal distribution having an average of 0 and a standard deviation of 1/√n. In the initialization of He, in a case where the number of nodes in a previous layer is n, parameters are initialized according to a normal distribution having an average of 0 and a standard deviation of √(2/n).

The latent representation calculation unit 23 calculates a latent representation z on the basis of the support sequence Es. The latent representation z is data indicating a feature of an event occurrence timing in the sequence Ev. The latent representation calculation unit 23 transmits the calculated latent representation z to the intensity function calculation unit 24.

Specifically, the latent representation calculation unit 23 includes a neural network 23-1. The neural network 23-1 is a mathematical model modeled to output a latent representation using a sequence as an input. The neural network 23-1 is configured to be able to input variable-length data. The plurality of parameters p1 is applied to the neural network 23-1 as weights and bias terms. The neural network 23-1 to which the plurality of parameters p1 is applied outputs the latent representation z using the support sequence Es as an input. The neural network 23-1 transmits the output latent representation z to the intensity function calculation unit 24.

The intensity function calculation unit 24 calculates an intensity function λ(t) on the basis of the latent representation z and the time t. The intensity function λ(t) is a function of time indicating a likelihood of occurrence of an event in a future time zone (for example, occurrence probability). The intensity function calculation unit 24 transmits the calculated intensity function λ(t) to the update unit 25.

Specifically, the intensity function calculation unit 24 includes a first monotonic neural network 24-1a, a second monotonic neural network 24-1b, a cumulative intensity function calculation unit 24-2, and an automatic differentiation unit 24-3.

The first monotonic neural network 24-1a is a mathematical model modeled to calculate, as an output, a scalar value according to a monotonically increasing function defined by a latent representation and time. The second monotonic neural network 24-1b is a mathematical model modeled to calculate, as an output, a scalar value according to a monotonically increasing function defined by a latent representation, a period, and time.

A plurality of weights and bias terms based on the plurality of parameters p2a are applied to the first monotonic neural network 24-1a. In a case where a negative value is included in the weights of the plurality of parameters p2a, the negative value is converted into a non-negative value by operation such as taking an absolute value.

In a case where the weights of the plurality of parameters p2a are non-negative values, the plurality of parameters p2a may be applied as they are to the first monotonic neural network 24-1a as the weights and the bias terms. That is, each weight applied to the first monotonic neural network 24-1a is a non-negative value.

The first monotonic neural network 24-1a to which the plurality of parameters p2a is applied calculates an output f(z, t) and the like as scalar values according to a monotonically increasing function defined by the latent representation a and the time t. The first monotonic neural network 24-1a transmits the output f(z, t) and the like to the cumulative intensity function calculation unit 24-2.

A plurality of weights and bias terms based on the plurality of parameters p2b are applied to the second monotonic neural network 24-1b. In a case where a negative value is included in the weights of the plurality of parameters p2b, the negative value is converted into a non-negative value by operation such as taking an absolute value.

In a case where the weights of the plurality of parameters p2b are non-negative values, the plurality of parameters p2b may be applied as they are to the second monotonic neural network 24-1b as the weights and the bias terms. That is, each weight applied to the second monotonic neural network 24-1b is a non-negative value.

The second monotonic neural network 24-1b to which the plurality of parameters p2b is applied calculates an outputs g(z, t′), g(z, τ), and the like as scalar values according to a monotonically increasing function defined by the latent representation z, the time t, the time t′, and the period τ.

The time t′ is calculated according to Formula (1) below. The period τ is a period such as one day or one week, and is set in advance.

$$[ Math . 1 ]$$

$${t}^{′} = t - ⌊ \frac{t}{τ} ⌋ τ \qquad Formula ( 1 )$$

The second monotonic neural network 24-1b transmits the outputs g(z, t′), g(z, τ), and the like to the cumulative intensity function calculation unit 24-2.

The cumulative intensity function calculation unit 24-2 calculates a cumulative intensity function Λ(t) on the basis of the period τ, the outputs f(z, t), g(z, t′), g(z, τ), and the like according to Formulas (2), (3), and (4) below.

A function λ₁(u) in Formula (3) and the like is a non-periodic portion in the intensity function, and a function λ₂(u) in Formula (4) and the like is a periodic portion in the intensity function. The terms f(z, t) and f(z, 0) on the right side of Formula (3) related to λ₁(u) are calculated by the first monotonic neural network 24-1a. The terms g(z, t′), g(z, τ), and g(z, 0) on the right side of Formula (4) related to λ₂(u) are calculated by the second monotonic neural network 24-1b.

An intensity function of any shape with the period τ can be defined by Formula (4). Thus, while knowledge by a human that there is a periodicity is incorporated in a model, it is not necessary to assume that a shape thereof is restricted, that is, expressive power required for each monotonic neural network is limited.

$$[ Math . 2 ]$$

$$Λ ( t ) = {\int }_{0}^{t} λ ( u ) du = {\int }_{0}^{t} {λ}_{1} ( u ) du + {\int }_{0}^{t} {λ}_{2} ( u ) du \qquad Formula ( 2 )$$

$${\int }_{0}^{t} {λ}_{1} ( u ) du = f ( z , t ) - f ( z , 0 ) \qquad Formula ( 3 )$$

$${\int }_{0}^{t} {λ}_{2} ( u ) du - g ( z , {t}^{′} ) + ⌊ \frac{t}{τ} ⌋ g ( z , τ ) - ( ⌊ \frac{t}{τ} ⌋ + 1 ) g ( z , 0 ) \qquad Formula ( 4 )$$

As indicated in Formulas (2) to (4), the cumulative intensity function Λ(t) includes the outputs f(z, t) and f(z, 0) from the first monotonic neural network 24-1a, and the outputs g(z, t′) and the like from the second monotonic neural network 24-1b taken into consideration. The cumulative intensity function calculation unit 24-2 transmits the calculated cumulative intensity function Λ(t) to the automatic differentiation unit 24-3.

The automatic differentiation unit 24-3 calculates the intensity function λ(t) by automatically differentiating the cumulative intensity function Λ(t). The automatic differentiation unit 24-3 transmits the calculated intensity function λ(t) to the update unit 25,

The update unit 25 updates the plurality of parameters p1, p2a, and p2b on the basis of the intensity function λ(t) and the query sequence Eq. The plurality of updated parameters p1, p2a, and p2b are applied to the neural network 23-1, the first monotonic neural network 24-1a, and the second monotonic neural network 24-1b on a one-to-one basis, respectively. In addition, the update unit 25 transmits the plurality of updated parameters p1, p2a, and p2b to the determination unit 25.

Specifically, the update unit 25 includes an evaluation function calculation unit 25-1 and an optimization unit 25-2.

The evaluation function calculation unit 25-1 calculates an evaluation function L(Eq) on the basis of the intensity function λ(t) and the query sequence Eq. The evaluation function L(Eq) is, for example, a negative log likelihood. The evaluation function calculation unit 25-1 transmits the calculated evaluation function L(Eq) to the optimization unit 25-2.

The optimization unit 25-2 optimizes the plurality of parameters p1, p2a, and p2b on the basis of the evaluation function L(Eq). For example, an error backpropagation method is used for the optimization. The optimization unit 25-2 updates, with the plurality of optimized parameters p1, p2a, and p2b, the plurality of parameters p1, p2a, and p2b that are applied to the neural network 23-1, the first monotonic neural network 24-1a, and the second monotonic neural network 24-1b on a one-to-one basis. In addition, the optimization unit 25-2 may optimize the parameters on the basis of the negative log likelihood in which the event in the support sequence Es is considered.

The determination unit 26 determines whether or not a condition is satisfied on the basis of the plurality of updated parameters p1, p2a, and p2b. The condition may be, for example, that the number of times the plurality of parameters p1, p2a, and p2b are transmitted to the determination unit 26 (that is, the number of parameter update loops) is greater than or equal to a threshold. The condition may be, for example, that an amount of change of values before and after the update of the plurality of parameters p1, p2a, and p2b is less than or equal to a threshold. In a case where the condition is not satisfied, the determination unit 26 repeatedly executes the parameter update loop by the data extraction unit 21, the latent representation calculation unit 23, the intensity function calculation unit 24, and the update unit 25. In a case where the condition is satisfied, the determination unit 26 ends the parameter update loop and causes the memory 11 to store the plurality of parameters p1, p2a, and p2b updated last as the learned parameter 27. In the following description, a plurality of parameters in the learned parameter 27 will be described as p1*, p2a*, and p2b* in order to be distinguished from parameters before learning.

With the above configuration, the event prediction apparatus 1 has a function of generating the learned parameter 27 on the basis of the learning data set 20.

### 1.1.3 Prediction Function Configuration

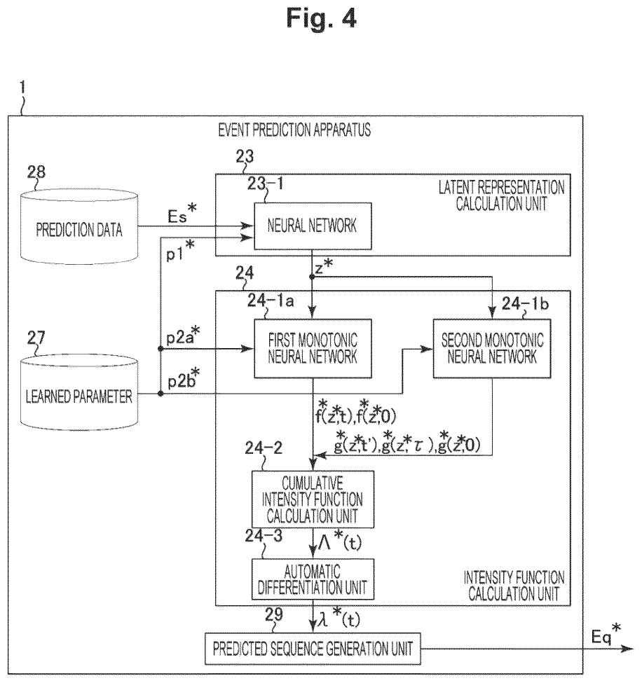

FIG. 4 is a block diagram illustrating an example of a configuration of the prediction function of the event prediction apparatus according to the first embodiment.

The CPU of the control circuit 10 deploys the prediction program stored in the memory 11 or the storage medium 15 to the RAM. Then, the CPU of the control circuit 10 interprets and executes the prediction program deployed on the RAM to control the memory 11, the communication module 12, the user interface 13, the drive 14, and the storage medium 15. As a result, as illustrated in FIG. 4, the event prediction apparatus 1 further functions as a computer including the latent representation calculation unit 23, the intensity function calculation unit 24, and a predicted sequence generation unit 29. In addition, the memory 11 of the event prediction apparatus 1 further stores prediction data 28 as information used for the prediction operation. Note that FIG. 4 illustrates a case where the plurality of parameters p1*, p2a*, and p2b* is applied from the learned parameter 27 to the neural network 23-1, the first monotonic neural network 24-1a, and the second monotonic neural network 24-1b on a one-to-one basis, respectively.

In a case where the learning data set 20 is a set of event sequences of a plurality of users in a certain EC site, the prediction data 28 corresponds to, for example, an event sequence for the next one week of a new user. In a case where the learning data set 20 is a set of event sequences of a certain user in a plurality of EC sites, the prediction data 28 corresponds to, for example, an event sequence for the next one week of the user in another EC site,

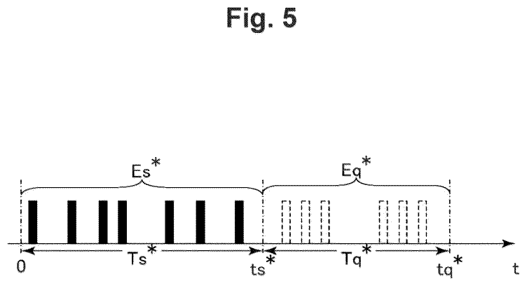

FIG. 5 is a diagram illustrating an example of a configuration of the prediction data of the event prediction apparatus according to the first embodiment. As illustrated in FIG. 5, the prediction data 28 includes a prediction sequence Es*. The prediction sequence Es* is information including an occurrence time of an event that has occurred before a period desired to be predicted. Specifically, the prediction sequence Es* includes occurrence times tᵢ (1≤i≤I*) of I* events that has occurred during a period Ts*=[0, ts*] (I* is an integer greater than or equal to 1).

That is, a period Tq*=[ts*, tq*] subsequent to the period Ts* is a period during which occurrence of an event is predicted in the prediction operation. Hereinafter, information including an occurrence time of an event predicted in the period Tq* is referred to as a predicted sequence Eq*.

Referring again to FIG. 4, a configuration will be described of the prediction function of the event prediction apparatus 1.

The latent representation calculation unit 23 inputs the prediction sequence Es* in the prediction data 28 to the neural network 23-1. The neural network 23-1 to which the plurality of parameters p1* is applied outputs a latent representation z* using the prediction sequence Es* as an input. The neural network 23-1 transmits the output latent representation z* to the first monotonic neural network 24-1a and the second monotonic neural network 24-1b in the intensity function calculation unit 24.

The first monotonic neural network 24-1a to which the plurality of parameters p2a* is applied calculates outputs f*(z*, t) and f*(z*, 0) according to a monotonically increasing function defined by the latent representation z* and the time t. The first monotonic neural network 24-1a transmits the outputs f*(z*, t) and f*(z*, 0) to the cumulative intensity function calculation unit 24-2.

The second monotonic neural network 24-1b to which the plurality of parameters p2b* is applied calculates outputs g*(z*, t′), g*(z*, τ), and g*(z*, 0) according to a monotonically increasing function defined by the latent representation z*, the time t, the time t′, and the period τ. The second monotonic neural network 24-1b transmits calculated values to the cumulative intensity function calculation unit 24-2.

The cumulative intensity function calculation unit 24-2 calculates a cumulative intensity function Λ*(t) on the basis of the period τ, and the outputs f*(z*, t), g*(z*, t′), g*(z*, τ), and the like according to Formulas (2) to (4) described above (where z, f, g, λ, and Λ are replaced with z*, f*, g*, λ*, and Λ*). The cumulative intensity function calculation unit 24-2 transmits the calculated cumulative intensity function Λ*(t) to the automatic differentiation unit 24-3.

The automatic differentiation unit 24-3 calculates an intensity function λ*(t) by automatically differentiating the cumulative intensity function Λ*(t). The automatic differentiation unit 24-3 transmits the calculated intensity function λ*(t) to the predicted sequence generation unit 29.

The predicted sequence generation unit 29 generates the predicted sequence Eq* on the basis of the intensity function λ*(t). The predicted sequence generation unit 29 outputs the generated predicted sequence Eq* to the user. The predicted sequence generation unit 29 may output the intensity function λ*(t) to the user. Note that, in order to generate the predicted sequence Eq*, for example, simulation using a Lewis method or the like is executed. Information on the Lewis method is disclosed in, for example, a literature “Yosihiko OGATA, “On Lewis' Simulation Method for Point Processes,” IEEE Transactions on Information Theory, Vol. 27, Issue. 1, January 1981, <https://ieeexplore.ieee.org/abstract/document/1056305>”.

With the above configuration, the event prediction apparatus 1 has a function of predicting the predicted sequence Eq* subsequent to the prediction sequence Es* on the basis of the learned parameter 27.

### 1.2. Operation

Next, operation will be described of the event prediction apparatus according to the first embodiment.

### 1.2.1 Learning Operation

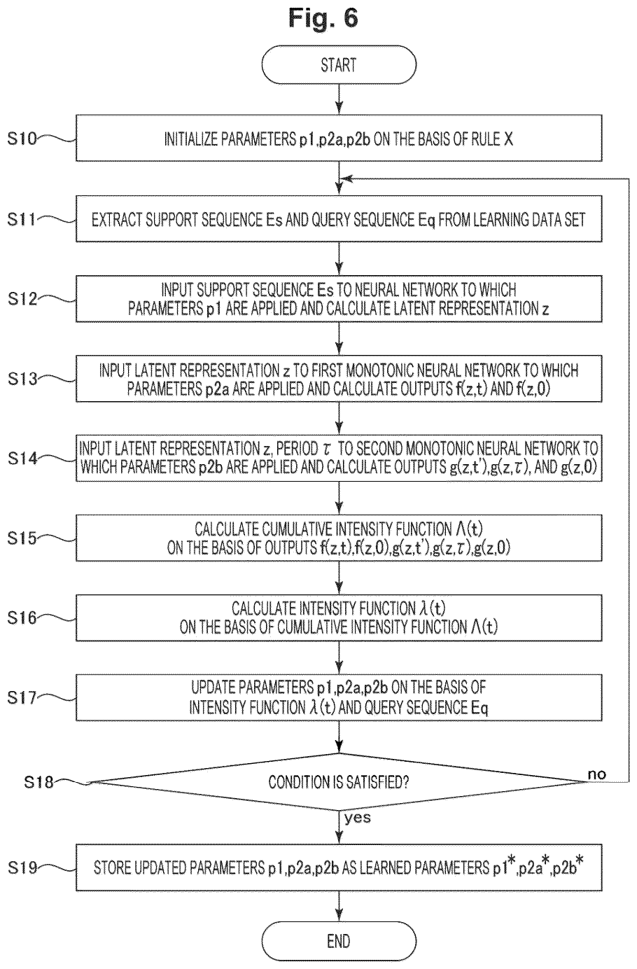

FIG. 6 is a flowchart illustrating an example of the learning operation in the event prediction apparatus according to the first embodiment. In the example of FIG. 6, it is assumed that the learning data set 20 is stored in the memory 11 in advance.

As illustrated in FIG. 6, in response to a learning operation start instruction from the user (start), the initialization unit 22 initializes the plurality of parameters p1, p2a, and p2b on the basis of the rule X (S10). For example, the initialization unit 22 initializes the plurality of parameters p1, p2a, and p2b on the basis of initialization of Xavier or initialization of He. The plurality of parameters p1, p2a, and p2b initialized by the processing of S10 are applied to the neural network 23-1, the first monotonic neural network 24-1a, and the second monotonic neural network 24-1b, respectively.

The data extraction unit 21 extracts the sequence Ev from the learning data set 20. Subsequently, the data extraction unit 21 further extracts the support sequence Es and the query sequence Eq from the extracted sequence Ev (S11).

The neural network 23-1 to which the plurality of parameters p1 initialized by the processing of S10 is applied calculates the latent representation z using the support sequence Es extracted in the processing of S11 as an input (S12).

The first monotonic neural network 24-1a to which the plurality of parameters p2a initialized by the processing of S10 is applied calculates the outputs f(z, t) and f(z, 0) according to a monotonically increasing function defined by the latent representation z calculated in the processing of S12 and the time t (S13).

The second monotonic neural network 24-1b to which the plurality of parameters p2b initialized by the processing of S10 is applied calculates the outputs g(z, t′), g(z, τ), and g(z, 0) according to a monotonically increasing function defined by the latent representation z calculated in the processing of S12, the time t, the time t′, and the period τ (S14).

The cumulative intensity function calculation unit 24-2 calculates the cumulative intensity function Λ(t) on the basis of the outputs f(z, t) and f(z, 0) calculated in the processing of S13 and the outputs calculated in the processing of S14 (S15).

The automatic differentiation unit 24-3 calculates the intensity function λ(t) on the basis of the cumulative intensity function Λ(t) calculated in the processing of S15 (S16).

The update unit 25 updates the plurality of parameters p1, p2a, and p2b on the basis of the intensity function λ(t) calculated in S16 and the query sequence Eq extracted in the processing of S11 (S17). Specifically, the evaluation function calculation unit 25-1 calculates the evaluation function L(Eq) on the basis of the intensity function λ(t) and the query sequence Eq. The optimization unit 25-2 calculates the plurality of optimized parameters p1, p2a, and p2b based on the evaluation function L(Eq) using the error backpropagation method. The optimization unit 25-2 applies the plurality of optimized parameters p1, p2a, and p2b to the neural network 23-1, the first monotonic neural network 24-1a, and the second monotonic neural network 24-1b on a one-to-one basis, respectively.

The determination unit 26 determines whether or not the condition is satisfied on the basis of the plurality of parameters p1, p2a, and p2b (S18).

In a case where the condition is not satisfied (S18; no), the data extraction unit 21 extracts a new support sequence Es and query sequence Eq from the learning data set 20 (S11). Then, the processing of S12 to S18 is executed on the basis of the extracted new support sequence Es and query sequence Eq, and the plurality of parameters p1, p2a, and p2b updated in the processing of S17. As a result, update processing for the plurality of parameters p1, p2a, and p2b is repeated until it is determined that the condition is satisfied by the processing of S18.

In a case where the condition is satisfied (S18; yes), the determination unit 26 causes the learned parameter 27 to store the plurality of parameters p1, p2a, and p2b updated last by the processing of S17 as p1*, p2a*, and p2b* (S19).

When the processing of S19 ends, the learning operation in the event prediction apparatus 1 ends (end).

### 1.2.2 Prediction Operation

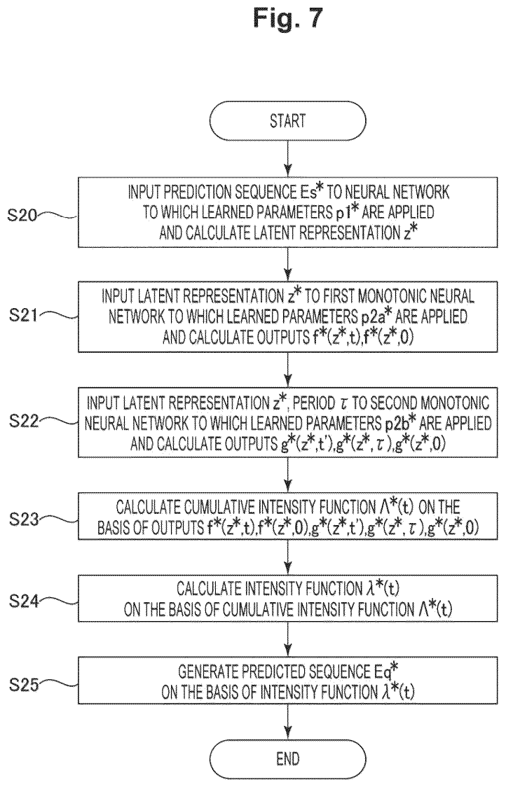

FIG. 7 is a flowchart illustrating an example of the prediction operation in the event prediction apparatus according to the first embodiment. In the example of FIG. 7, it is assumed that the plurality of parameters p1*, p2a*, and p2b* in the learned parameter 27 are applied to the neural network 23-1, the first monotonic neural network 24-1a, and the second monotonic neural network 24-1b on a one-to-one basis, respectively, by the learning operation executed in advance. In addition, in the example of FIG. 7, it is assumed that the prediction data 28 is stored in the memory 11.

As illustrated in FIG. 7, in response to a prediction operation start instruction from the user (start), the neural network 23-1 to which the plurality of parameters p1* is applied calculates the latent representation z* using the prediction sequence Es* as an input (S20).

The first monotonic neural network 24-1a to which the plurality of parameters p2a is applied calculates the outputs f*(z*, t) and f*(z*, 0) according to a monotonically increasing function defined by the latent representation z* calculated in the processing of S20 and the time t (S21).

The second monotonic neural network 24-1b to which the plurality of parameters p2b* is applied calculates the outputs g*(z*, t′), g*(z*, τ), and g*(z*, 0) according to a monotonically increasing function defined by the latent representation z* calculated in the processing of S20, the time t, the time t′, and the period τ (S22).

The cumulative intensity function calculation unit 24-2 calculates the cumulative intensity function Λ*(t) on the basis of the outputs f*(z*, t) and f*(z*, 0) calculated in the process of S21 and the outputs g*(z*, t′), g*(z*, τ), and g*(z*, 0) calculated in the processing of S22 (S23).

The automatic differentiation unit 24-3 calculates the intensity function λ*(t) on the basis of the cumulative intensity function Λ*(t) calculated in the processing of S23 (S24).

The predicted sequence generation unit 29 generates the predicted sequence Eq* on the basis of the intensity function λ*(t) calculated in S24 (S25). Then, the predicted sequence generation unit 29 outputs the predicted sequence Eq* generated in the processing of S25 to the user.

When the processing of S25 ends, the prediction operation in the event prediction apparatus 1 ends (end).

### 1.3 Effects According to First Embodiment

According to the first embodiment, the first monotonic neural network 24-1a is configured to calculate the outputs f(z, t), and f(z, 0) according to a monotonically increasing function defined by the latent representation z of the support sequence Es and the time t.

The second monotonic neural network 24-1b is configured to calculate the outputs g(z, t′), g(z, τ), and g(z, 0) according to a monotonically increasing function defined by the latent representation z of the support sequence Es, the time t, the time t′, and the period τ.

The cumulative intensity function calculation unit 24-2 calculates the cumulative intensity function Λ(t) on the basis of the outputs f(z, t) and f(z, 0), and g(z, t′), g(z, τ), and g(z, 0).

As a result, the first monotonic neural network 24-1a does not need to express a periodic change. Therefore, it is possible to alleviate demand for the expressive power required for the outputs of the first monotonic neural network 24-1a.

In addition, the automatic differentiation unit 24-3 calculates the intensity function λ(t) regarding the point process on the basis of the cumulative intensity function Λ(t). As a result, the first monotonic neural network 24-1a and the second monotonic neural network 24-1b can be used for modeling the point process. Therefore, long-term prediction of an event can be performed using the first monotonic neural network 24-1a and the second monotonic neural network 24-1b.

### 2. Second Embodiment

Next, an information processing apparatus according to a second embodiment will be described.

In the first embodiment described above, a case has been described where a neural network is used hat outputs the latent representation z using the support sequence Es as an input in modeling of the intensity function λ(t); however, embodiments are not limited thereto. For example, the modeling of the intensity function λ(t) may be achieved by being combined with a meta-learning method such as model-agnostic meta-learning (MAML). Hereinafter, a configuration and operation different from those of the first embodiment will be mainly described. Then, description of the configuration and operation equivalent to those of the first embodiment will be omitted as appropriate.

### 2.1 Learning Function Configuration

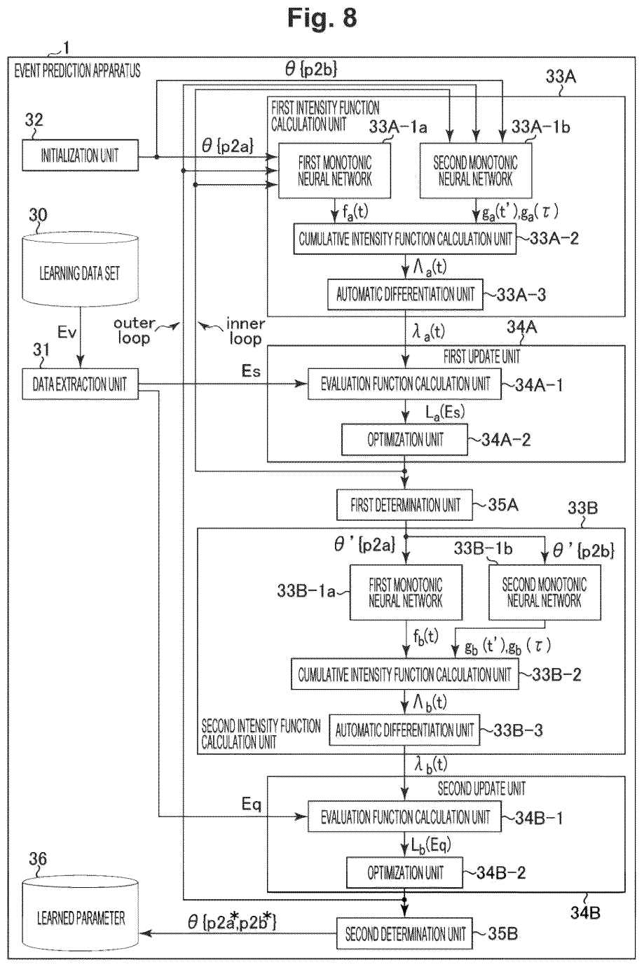

FIG. 8 is a block diagram illustrating an example of a configuration of a learning function of an event prediction apparatus according to the second embodiment.

As illustrated in FIG. 8, the event prediction apparatus 1 functions as a computer including a data extraction unit 31, an initialization unit 32, a first intensity function calculation unit 33A, a second intensity function calculation unit 33B, a first update unit 34A, a second update unit 34B, a first determination unit 35A, and a second determination unit 35B. In addition, the memory 11 of the event prediction apparatus 1 stores a learning data set 30 and a learned parameter 36 as information used for the learning operation.

The learning data set 30 and the data extraction unit 31 are equivalent to the learning data set 20 and the data extraction unit 21 in the first embodiment. That is, the data extraction unit 31 extracts the support sequence Es and the query sequence Eq from the learning data set 30.

The initialization unit 32 initializes the plurality of parameters p2a and p2b on the basis of the rule X. The initialization unit 32 transmits the plurality of initialized parameters p2a and p2b to the first intensity function calculation unit 33A. Note that, hereinafter, a set of the plurality of parameters p2a and p2b is also referred to as a parameter set θ{p2a, p2b}. In addition, the plurality of parameters p2a and p2b in the parameter set θ{p2a, p2b} are also referred to as a plurality of parameters θ{p2a} and θ{p2b}, respectively.

The first intensity function calculation unit 33A calculates an intensity function λₐ(t) on the basis of the time t. The first intensity function calculation unit 33A transmits the calculated intensity function λₐ(t) to the first update unit 34A.

Specifically, the first intensity function calculation unit 33A includes a first monotonic neural network 33A-1a, a second monotonic neural network 33A-1b, a cumulative intensity function calculation unit 33A-2, and an automatic differentiation unit 33A-3.

The first monotonic neural network 33A-1a is a mathematical model modeled to calculate a scalar value according to a monotonically increasing function defined by time as an output. A plurality of weights and bias terms based on the plurality of parameters θ{p2a} are applied to the first monotonic neural network 33A-1a. Each weight applied to the first monotonic neural network 33A-1a is a non-negative value. The first monotonic neural network 33A-1a to which the plurality of parameters θ{p2a} is applied calculates outputs fₐ(t) and fₐ(0) according to a monotonically increasing function defined by the time t. The first monotonic neural network 33A-1a transmits the calculated outputs fₐ(t) and fₐ(0) to the cumulative intensity function calculation unit 33A-2.

In addition, the second monotonic neural network 33A-1b is a mathematical model modeled to calculate a scalar value according to a monotonically increasing function defined by a period and time as an output. A plurality of weights and bias terms based on the plurality of parameters θ{p2b} are applied to the second monotonic neural network 33A-1b. Each weight applied to the second monotonic neural network 33A-1b is a non-negative value. The second monotonic neural network 33A-1b to which the plurality of parameters θ{p2b} is applied calculates outputs gₐ(t′), gₐ(τ), and gₐ(0) according to a monotonically increasing function defined by the time t, the time t′, and the period τ. The second monotonic neural network 33A-1b transmits the calculated outputs gₐ(t′), gₐ(τ), and gₐ(0) to the cumulative intensity function calculation unit 33A-2.

The cumulative intensity function calculation unit 33A-2 calculates a cumulative intensity function Λₐ(t) on the basis of the period τ, the outputs fₐ(t), fₐ(0), gₐ(t′), gₐ(τ), and gₐ(0) according to Formulas (5), (6), and (7) below.

$$[ Math . 3 ]$$

$${Λ}_{a} ( t ) = {\int }_{0}^{t} {λ}_{a} ( u ) du = {\int }_{0}^{t} {λ}_{a 1} ( u ) du + {\int }_{0}^{t} {λ}_{a 2} ( u ) du \qquad Formula ( 5 )$$

$${\int }_{0}^{t} {λ}_{a 1} ( u ) du = {f}_{a} ( t ) - {f}_{a} ( 0 ) \qquad Formula ( 6 )$$

$${\int }_{0}^{t} {λ}_{a 2} ( u ) du = {g}_{a} ( {t}^{′} ) + ⌊ \frac{t}{τ} ⌋ {g}_{a} ( τ ) - ( ⌊ \frac{t}{τ} ⌋ + 1 ) {g}_{a} ( 0 ) \qquad Formula ( 7 )$$

The cumulative intensity function calculation unit 33A-2 transmits the calculated cumulative intensity function Λₐ(t) to the automatic differentiation unit 33A-3.

The automatic differentiation unit 33A-3 calculates the intensity function λₐ(t) by automatically differentiating the cumulative intensity function Λₐ(t). The automatic differentiation unit 33A-3 transmits the calculated intensity function λₐ(t) to the first update unit 34A.

The first update unit 34A updates the parameter set θ{p2a, p2b} on the basis of the intensity function λₐ(t) and the support sequence Es. The plurality of updated parameters θ{p2a} and θ{p2a} are applied to the first monotonic neural network 33A-1a and the second monotonic neural network 33A-1b, respectively. In addition, the first update unit 34A transmits the updated parameter set θ{p2a, p2b} to the first determination unit 35A.

Specifically, the first update unit 34A includes an evaluation function calculation unit 34A-1 and an optimization unit 34A-2.

The evaluation function calculation unit 34A-1 calculates an evaluation function Lₐ(Es) on the basis of the intensity function λₐ(t) and the support sequence Es. The evaluation function Lₐ(Es) is, for example, a negative log likelihood. The evaluation function calculation unit 34A-1 transmits the calculated evaluation function Lₐ(Es) to the optimization unit 34A-2.

The optimization unit 34A-2 optimizes the parameter set θ{p2a, p2b} on the basis of the evaluation function Lₐ (Es). For example, the error backpropagation method is used for the optimization. The optimization unit 34A-2 updates the parameter set θ{p2a, p2b} applied to the first monotonic neural network 33A-1a and the second monotonic neural network 33A-1b with the optimized parameter set θ{p2a, p2b}.

The first determination unit 35A determines whether or not a first condition is satisfied on the basis of the updated parameter set θ{p2a, p2b}. The first condition may be, for example, that the number of times the parameter set θ{p2a, p2b} is transmitted to the first determination unit 35A (that is, the number of parameter set update loops in the first intensity function calculation unit 33A and the first update unit 34A) is greater than or equal to a threshold. The first condition may be, for example, that an amount of change of values before and after the update of the parameter set θ{p2a, p2b} is less than or equal to a threshold. Hereinafter, the parameter set update loop in the first intensity function calculation unit 33A and the first update unit 34A is also referred to as an inner loop.

In a case where the first condition is not satisfied, the first determination unit 35A repeatedly executes the update by the inner loop. In a case where the first condition is satisfied, the first determination unit. 35A ends the update by the inner loop and transmits the parameter set θ{p2a, p2b} updated last to the second intensity function calculation unit 33B. In the following description, a parameter set transmitted to the second intensity function calculation unit 33B in the learning function will be described as θ′{p2a, p2b} in order to be distinguished from a parameter set before learning.

The second intensity function calculation unit 33B calculates an intensity function λₐ(t) on the basis of the time t, the time t′, and the period τ. The second intensity function calculation unit 33B transmits the calculated intensity function λ_{b}(t) to the second update unit 34B.

Specifically, the second intensity function calculation unit 33B includes a first monotonic neural network 33B-1a, a second monotonic neural network 33B-1b, a cumulative intensity function calculation unit 33B-2, and an automatic differentiation unit 33B-3.

The first monotonic neural network 33B-1a is a mathematical model modeled to calculate a scalar value according to a monotonically increasing function defined by time as an output. A plurality of parameters θ′{p2a} is applied to the first monotonic neural network 33B-1a as weights and bias terms. The first monotonic neural network 33B-1a to which the plurality of parameters θ′{p2a} is applied calculates outputs f_{b}(t) and f_{b}(0) according to a monotonically increasing function defined by the time t. The first monotonic neural network 33B-1a transmits the calculated outputs f_{b}(t) and f_{b}(0) to the cumulative intensity function calculation unit 33B-2.

The second monotonic neural network 33B-1b is a mathematical model modeled to calculate a scalar value according to a monotonically increasing function defined by time and a period as an output. A plurality of parameters θ′{p2b} is applied to the second monotonic neural network 33B-1b as weights and bias terms. The second monotonic neural network 33B-1b to which the plurality of parameters θ′{p2b} is applied calculates outputs g_{b}(t′), g_{b}(τ), and g_{b}(0) according to a monotonically increasing function defined by the time t, the time t′, and the period τ. The second monotonic neural network 33B-1b transmits the calculated outputs g_{b}(t′), g_{b}(τ), and g_{b}(0) to the cumulative intensity function calculation unit 33B-2.

The cumulative intensity function calculation unit 33B-2 calculates a cumulative intensity function Λ_{b}(t) on the basis of the period τ and the outputs f_{b}(t), f_{b}(0), g_{b}(t′), g_{b}(τ), and g_{b}(0) according to Formulas (5), (6), and (7) described above (where Λₐ, fₐ, and gₐ are replaced with Λ_{b}, f_{b}, and g_{b}). The cumulative intensity function calculation unit 33B-2 transmits the calculated cumulative intensity function Λ_{b}(t) to the automatic differentiation unit 33B-3.

The automatic differentiation unit 33B-3 calculates the intensity function λ_{b}(t) by automatically differentiating the cumulative intensity function Λ_{b}(t). The automatic differentiation unit 33B-3 transmits the calculated intensity function λ_{b}(t) to the second update unit 34B.

The second update unit 34B updates the parameter set θ{p2a, p2b} on the basis of the intensity function λ_{b}(t) and the query sequence Eq. The plurality of updated parameters θ{p2a} and θ{p2b} are applied to the first monotonic neural network 33A-1a and the second monotonic neural network 33A-1b, respectively. In addition, the second update unit 34B transmits the updated parameter set θ{p2a, p2b} to the second determination unit 35B.

Specifically, the second update unit 34B includes an evaluation function calculation unit 34B-1 and an optimization unit 34B-2.

The evaluation function calculation unit 34B-1 calculates an evaluation function L_{b}(Eq) on the basis of the intensity function λ_{b}(t) and the query sequence Eq. The evaluation function L_{b}(Eq) is, for example, a negative log likelihood. The evaluation function calculation unit 34B-1 transmits the calculated evaluation function L_{b}(Eq) to the optimization unit 34B-2.

The optimization unit 34B-2 optimizes the parameter set θ{p2a, p2b} on the basis of the evaluation function L_{b}(Eq). For the optimization of the parameter set θ{p2a, p2b}, for example, the error backpropagation method is used. More specifically, the optimization unit 34B-2 calculates a second order differential regarding the parameter set θ{p2a, p2b} of the evaluation function L_{b}(Eq) using the parameter set θ′{p2a, p2b} to optimize the parameter set θ{p2a, p2b}. Then, the optimization unit. 34B-2 updates the parameter set θ{p2a, p2b} applied to the first monotonic neural network 33A-1a and the second monotonic neural network 33A-1b with the optimized parameter set θ{p2a, p2b}.

The second determination unit 35B determines whether or not a second condition is satisfied on the basis of the updated parameter set θ{p2a, p2b}. The second condition may be, for example, that the number of times the parameter set θ{p2a, p2b} is transmitted to the second determination unit 35B (that is, the number of parameter set update loops in the second intensity function calculation unit 33B and the second update unit 34B) is greater than or equal to a threshold. The second condition may be, for example, that the amount of change of values before and after the update of the parameter set θ{p2a, p2b} is less than or equal to a threshold. Hereinafter, the parameter set update loop in the second intensity function calculation unit 33B and the second update unit 34B is also referred to as an outer loop.

In a case where the second condition is not satisfied, the second determination unit 35B repeatedly executes the update of the parameter set by the outer loop. In a case where the second condition is satisfied, the second determination unit 35B ends the update of the parameter set by the outer loop and causes the memory 11 to store the parameter set θ{p2a, p2b} updated last as the learned parameter 36. In the following description, a parameter set in the learned parameter 36 will be described as θ{p2a*, p2b*} in order to be distinguished from a parameter set before learning by the outer loop.

With the above configuration, the event prediction apparatus 1 has a function of generating the learned parameter 36 on the basis of the learning data set 30.

### 2.2 Prediction Punction Configuration

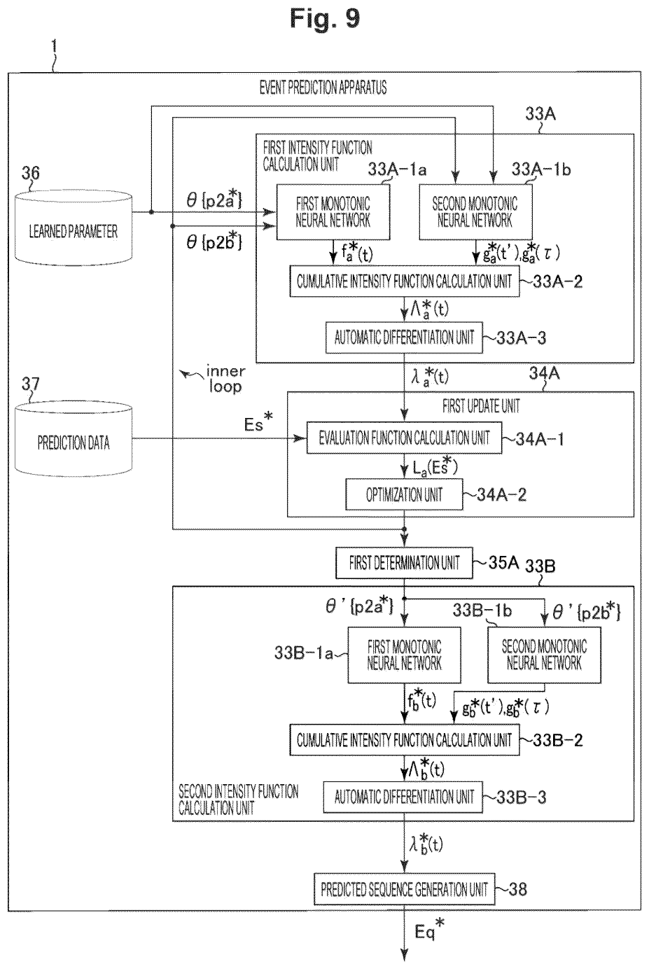

FIG. 9 is a block diagram illustrating an example of a configuration of a prediction function of the event prediction apparatus according to the second embodiment.

As illustrated in FIG. 9, the event prediction apparatus 1 further functions as a computer including the first intensity function calculation unit 33A, the first update unit 34A, the first determination unit 35A, the second intensity function calculation unit 33B, and A predicted sequence generation unit 38. In addition, the memory 11 of the event prediction apparatus 1 further stores prediction data 37 as information used for the prediction operation. A configuration of the prediction data 37 is equivalent to that of the prediction data 28 in the first embodiment.

Note that FIG. 9 illustrates a case where the parameter set θ{p2a*, p2b*} is applied from the learned parameter 36 to the first monotonic neural network 33A-1a and the second monotonic neural network 33A-1b.

The first monotonic neural network 33A-1a to which a plurality of parameters θ*{p2a*} is applied calculates outputs fₐ*(t) and fₐ*(0) according to a monotonically increasing function defined by the time t. The first monotonic neural network 33A-1a transmits the calculated outputs fₐ*(t) and fₐ*(0) to the cumulative intensity function calculation unit 33A-2.

In addition, the second monotonic neural network 33A-1b to which a plurality of parameters θ{p2b*} is applied calculates outputs gₐ*(t′), gₐ*(τ), and gₐ*(0) according to a monotonically increasing function defined by the time t, the time t′, and the period τ. The second monotonic neural network 33A-1b transmits the calculated outputs gₐ*(t′), gₐ*(τ), and gₐ*(0) to the cumulative intensity function calculation unit 33A-2.

The cumulative intensity function calculation unit 33A-2 calculates a cumulative intensity function Λₐ*(t) on the basis of the outputs fₐ*(t), fₐ*(0), gₐ*(t′), gₐ*(τ), and gₐ*(0) according to Formulas (5), (6), and (7) described above (where fₐ, gₐ, λₐ, and Λₐ are replaced with fₐ*, gₐ*, λₐ*, and Λₐ*). The cumulative intensity function calculation unit 33A-2 transmits the calculated cumulative intensity function Λₐ*(t) to the automatic differentiation unit 33A-3.

The automatic differentiation unit 33A-3 calculates an intensity function λₐ*(t) by automatically differentiating the cumulative intensity function Λₐ*(t). The automatic differentiation unit 33A-3 transmits the calculated intensity function λₐ*(t) to the first determination unit 35A.

The evaluation function calculation unit 34A-1 calculates an evaluation function Lₐ(Es*) on the basis of the intensity function λₐ*(t) and the prediction sequence Es*. The evaluation function Lₐ(Es*) is, for example, a negative log likelihood. The evaluation function calculation unit 34A-1 transmits the calculated evaluation function Lₐ(Es*) to the optimization unit 34A-2.

The optimization unit 34A-2 optimizes the parameter set θ{p2a*, p2b*} on the basis of the evaluation function Lₐ(Es*). For example, the error backpropagation method is used for the optimization. The optimization unit 34A-2 updates the parameter set θ{p2a*, p2b*} applied to the first monotonic neural network 33A-1a and the second monotonic neural network 33A-1b with the optimized parameter set θ{p2a*, p2b*}.

The first determination unit 35A determines whether or not a third condition is satisfied on the basis of the updated parameter set θ{p2a*, p2b*}. The third condition may be, for example, that the number of inner loops of the update of the parameter set θ{p2a*, p2b*} is greater than or equal to a threshold. The third condition may be, for example, that an amount of change of values before and after the update of the parameter set θ{p2a*, p2b*} is less than or equal to a threshold.

In a case where the third condition is not satisfied, the first determination unit 35A repeatedly executes the update of the parameter set by the inner loop. In a case where the third condition is satisfied, the first determination unit 35A ends the update of the parameter set by the inner loop and transmits the parameter set θ{p2a*, p2b*} updated last to the second intensity function calculation unit 33B. In the following description, a parameter set transmitted to the second intensity function calculation unit 33B in the prediction function will be described as θ′{p2a, p2b*} in order to be distinguished from a parameter set before inner loop learning.

The first monotonic neural network 33B-1a to which parameters θ′{p2a*} are applied calculates outputs f_{b}*(t) and f_{b}*(0) according to a monotonically increasing function defined by the time t. The first monotonic neural network 33B-1a transmits the calculated outputs f_{b}*(t) and f_{b}*(0) to the cumulative intensity function calculation unit 33B-2.

The second monotonic neural network 33B-1b to which parameters θ′{p2b*} are applied calculates outputs gt (t′), g_{b}*(τ), and g_{b}*(0) according to a monotonically increasing function defined by the time t, the time t′, and the period τ. The second monotonic neural network 33B-1b transmits the calculated outputs g_{b}*(t′), g_{b}*(τ), and g_{b}*(0) to the cumulative intensity function calculation unit 33B-2.

The cumulative intensity function calculation unit 33B-2 calculates a cumulative intensity function Λ_{b*}(t) on the basis of the period τ, the outputs f_{b}*(t), f_{b}*(0), g_{b}*(t′), g_{b}*(τ), and g_{b}*(0) according to Formulas (5), (6), and (7) described above (where fₐ, gₐ, λₐ, and Λₐ are replaced with f_{b}*, g_{b}*, λ_{b}*, and Λ_{b}*). The cumulative intensity function calculation unit 33B-2 transmits the calculated cumulative intensity function Λ_{b}*(t) to the automatic differentiation unit 33B-3.

The automatic differentiation unit 33B-3 calculates an intensity function λ_{b}*(t) by automatically differentiating the cumulative intensity function Λ_{b}*(t). The automatic differentiation unit 33B-3 transmits the calculated intensity function λ_{b}*(t) to the predicted sequence generation unit 38.

The predicted sequence generation unit 38 generates the predicted sequence Eq* on the basis of the intensity function λ_{b}*(t). The predicted sequence generation unit 38 outputs the generated predicted sequence Eq* to the user. Note that, in order to generate the predicted sequence Eq*, for example, simulation using a Lewis method or the like is executed.

With the above configuration, the event prediction apparatus 1 has a function of predicting the predicted sequence Eq* subsequent to the prediction sequence Es* on the basis of the learned parameter 36.

### 2.3 Learning Operation

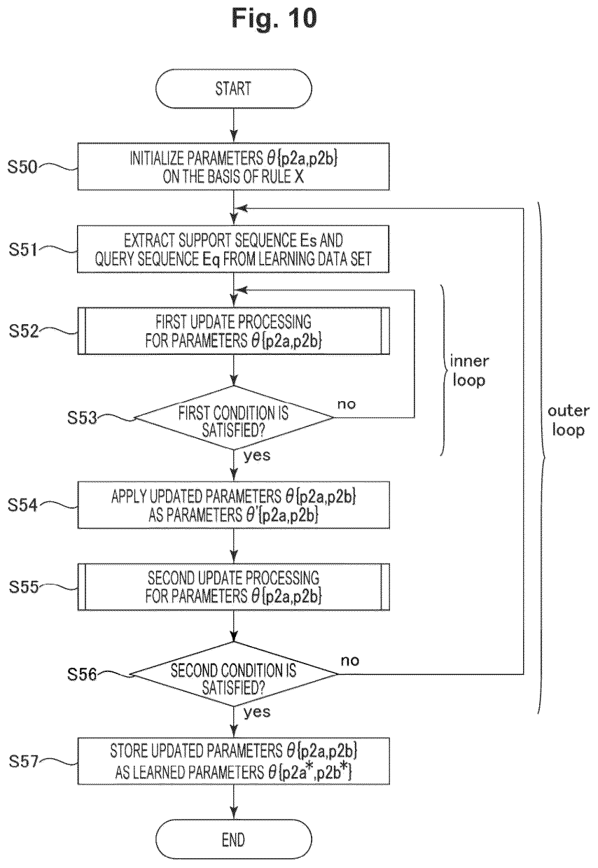

FIG. 10 is a flowchart illustrating an example of an outline of the learning operation in the event prediction apparatus according to the second embodiment. In the example of FIG. 10, it is assumed that the learning data set 30 is stored in the memory 11 in advance.

As illustrated in FIG. 10, in response to a learning operation start instruction from the user (start), the initialization unit 32 initializes the parameter set θ{p2a, p2b} on the basis of the rule X (S50). The parameter set θ{p2a, p2b} initialized by the processing of S50 is applied to the first intensity function calculation unit 33A.

The data extraction unit 31 extracts the sequence Ev from the learning data set 30. Subsequently, the data extraction unit 31 further extracts the support sequence Es and the query sequence Eq from the extracted sequence Ev (S51).

The first intensity function calculation unit 33A to which the parameter set θ{p2a, p2b} initialized by the processing of S50 is applied and the first update unit 34A execute first update processing for the parameter set θ{p2a, p2b} (S52). Details of the first update processing will be described later.

After the processing of S52, the first determination unit 35A determines whether or not the first condition is satisfied on the basis of the parameter set θ{p2a, p2b} updated in the processing of S52 (S53).

In a case where the first condition is not satisfied (S53; no), the first intensity function calculation unit 33A to which the parameter set θ{p2a, p2b} updated in the processing of S52 is applied and the first update unit 34A again execute the first update processing (S52). In this manner, the first update processing is repeated (inner loop) until it is determined that the first condition is satisfied in the processing of S53.

In a case where the first condition is satisfied (S53; yes), the first determination unit 35A applies the parameter set θ{p2a, p2b} updated last by the processing of S52 to the second intensity function calculation unit 33B as the parameter set θ′{p2a, p2b} (S54).

The second intensity function calculation unit 33B to which the parameter set θ′{p2a, p2b} is applied and the second update unit 34B execute second update processing for the parameter set θ{p2a, p2b} (S55). Details of the second update processing will be described later.

After the processing of S55, the second determination unit 35B determines whether or not the second condition is satisfied on the basis of the parameter set 74 {p2a, p2b} updated in the processing of S55 (S56).

In a case where the second condition is not satisfied (S56; no), the data extraction unit 31 extracts a new support sequence Es and query sequence Eq (S51). Then, the inner loop and the second update processing are repeated (outer loop) until it is determined that the second condition is satisfied in the processing of S56.

In a case where the second condition is satisfied (S56; yes), the second determination unit 35B causes the learned parameter 36 to store the parameter set θ{p2a, p2b} updated last by the processing of S55 as the parameter set θ{p2a*, p2b*} (S57).

When the processing of S57 ends, the learning operation in the event prediction apparatus 1 ends (end).

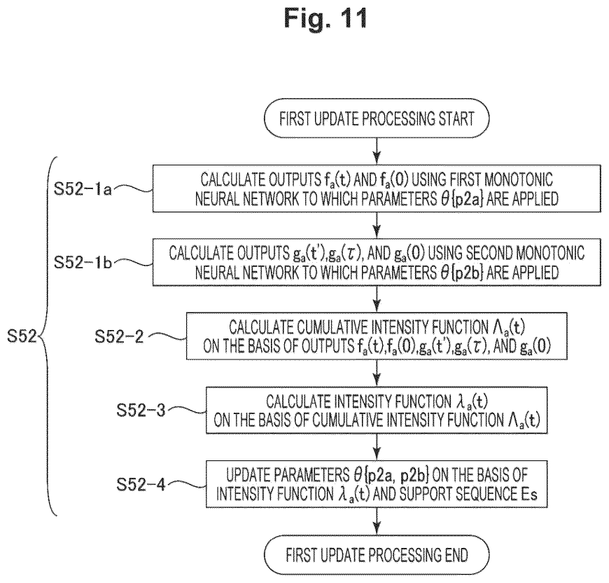

FIG. 11 is a flowchart illustrating an example of the first update processing in the event prediction apparatus according to the second embodiment. The processing of S52-1a to S52-4 illustrated in FIG. 11 corresponds to the processing of S52 in FIG. 10.

After the processing of S51 (start), the first monotonic neural network 33A-1a to which the plurality of parameters θ{p2a} initialized by the processing of S50 is applied calculates the outputs fₐ(t) and fₐ(0) according to a monotonically increasing function defined by the time t (S52-1a).

In addition, the second monotonic neural network 33A-1b to which the plurality of parameters θ{p2b} initialized in the processing of S50 is applied calculates the outputs gₐ(t′), gₐ(τ), and gₐ(0) according to a monotonically increasing function defined by the time t, the time t′, and the period τ (S52-1b).

The cumulative intensity function calculation unit 33A-2 calculates the cumulative intensity function Λₐ(t) on the basis of the outputs fₐ(t) and fₐ(0) calculated in the processing of S52-1a and gₐ(t′), gₐ(τ), and gₐ(0) calculated in the processing of S52-1b (S52-2).

The automatic differentiation unit 33A-3 calculates the intensity function λₐ(t) on the basis of the cumulative intensity function Λₐ(t) calculated in the processing of S52-2 (S52-3).

The first update unit 34A updates the parameter set θ{p2a, p2b} on the basis of the intensity function λₐ(t) calculated in S52-3 and the support sequence Es extracted in the processing of S51 (S52-4). Specifically, the evaluation function calculation unit 34A-1 calculates the evaluation function Lₐ(Rs) on the basis of the intensity function λₐ(t) and the support sequence Es. The optimization unit 34A-2 calculates the optimized parameter set θ{p2a, p2b} based on the evaluation function Lₐ(Es) using the error backpropagation method. The optimization unit 34A-2 applies the optimized parameter set θ{p2a, p2b} to the first monotonic neural network 33A-1a and the second monotonic neural network 33A-1b.

When the processing of S52-4 ends, the first update processing ends (end).

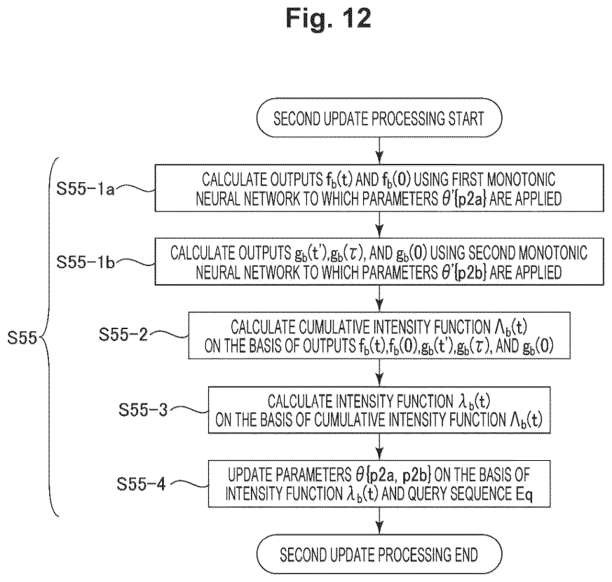

FIG. 12 is a flowchart illustrating an example of the second update processing in the event prediction apparatus according to the second embodiment. The processing of S55-1a to S55-4 illustrated in FIG. 12 corresponds to the processing of S55 in FIG. 10.

After the processing of S54 (start), the first monotonic neural network 33B-1a to which the plurality of parameters θ′{p2a} is applied calculates outputs f_{b}(t) and f_{b}(0) according to a monotonically increasing function defined by the time t (S55-1a).

In addition, the second monotonic neural network 33B-1b to which the plurality of parameters θ′{p2b} is applied calculates the outputs g_{b}(t′), g_{b}(τ), and g_{b}(0) according to a monotonically increasing function defined by the time t, the time t′, and the period τ (S55-1b).

The cumulative intensity function calculation unit 33B-2 calculates the cumulative intensity function Λ_{b}(t) on the basis of the outputs f_{b}(t) and f_{b}(0) calculated in the processing of S55-1a and g_{b}(t′), g_{b}(τ), and g_{b}(0) calculated in the processing of S55-1b (S55-2).

The automatic differentiation unit 33B-3 calculates the intensity function λ_{b}(t) on the basis of the cumulative intensity function Λ_{b}(t) calculated in the processing of S55-2 (S55-3).

The second update unit 34B updates the parameter set θ{p2a, p2b} on the basis of the intensity function λ_{b}(t) calculated in S55-3 and the query sequence Eq extracted in the processing of S51 (S55-4). Specifically, the evaluation function calculation unit 34B-1 calculates the evaluation function L_{b}(Eq) on the basis of the intensity function λ_{b}(t) and the query sequence Eq. The optimization unit 34B-2 calculates the optimized parameter set θ{p2a, p2b} based on the evaluation function L_{b}(Eq) using the error backpropagation method. The optimization unit 34B-2 applies the optimized parameter set θ{p2a, p2b} to the first monotonic neural network 33A-1a and the second monotonic neural network 33A-1b.

When the processing of S55-4 ends, the second update processing ends (end).

### 2.4 Prediction Operation

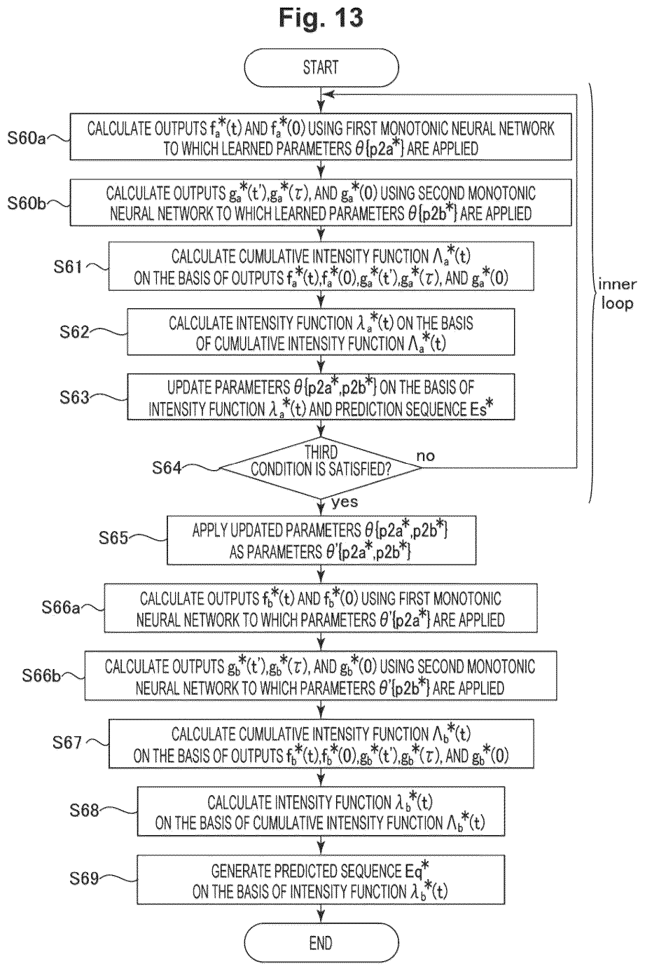

FIG. 13 is a flowchart illustrating an example of the prediction operation in the event prediction apparatus according to the second embodiment. In the example of FIG. 13, it is assumed that the parameter set θ{p2a*, p2b*} in the learned parameter 36 is applied to the first intensity function calculation unit 33A by the learning operation executed in advance. In addition, in the example of FIG. 13, it is assumed that the prediction data 37 is stored in the memory 11.

As illustrated in FIG. 13, in response to a prediction operation start instruction from the user (start), the first monotonic neural network 33A-1a to which the plurality of parameters θ{p2a*} is applied calculates the outputs fₐ*(t) and fₐ*(0) according to a monotonically increasing function defined by the time t (S60a).

In addition, the second monotonic neural network 33A-1b to which the plurality of parameters θ{p2b*} is applied calculates the outputs gₐ*(t′), gₐ*(τ), and gₐ*(0) according to a monotonically increasing function defined by the time t, the time t′, and the period τ (S60b).

The cumulative intensity function calculation unit 33A-2 calculates the cumulative intensity function Λₐ*(t) on the basis of the outputs fₐ*(t) and fₐ*(0) calculated in the processing of S60a and the outputs gₐ*(t′), gₐ*(τ), and gₐ*(0) calculated in the processing of S60b (S61).

The automatic differentiation unit 33A-3 calculates the intensity function λₐ*(t) on the basis of the cumulative intensity function Λₐ*(t) calculated in the processing of S61 (S62).

The first update unit 34A updates the parameter set θ{p2a*, p2b*} on the basis of the intensity function λₐ*(t) calculated in S62 and the prediction sequence Es* (S63). Specifically, the evaluation function calculation unit 34A-1 calculates the evaluation function Lₐ(Es*) on the basis of the intensity function λₐ*(t) and the prediction sequence Es*. The optimization unit 34A-2 calculates the optimized parameter set θ{p2a*, p2b*} based on the evaluation function Lₐ(Es*) using the error backpropagation method. The optimization unit 34A-2 applies the optimized parameter set θ{p2a*, p2b*} to the first monotonic neural network 33A-1a and the second monotonic neural network 33A-1b.

The first determination unit 35A determines whether or not the third condition is satisfied on the basis of the parameter set θ{p2a*, p2b*} updated in the processing of S63 (S64).

In a case where the third condition is not satisfied (S64; no), the first intensity function calculation unit 33A to which the parameter set θ{p2a*, p2b*} updated in the processing of S63 is applied and the first update unit 34A further execute the processing of S60a to S64. In this manner, update processing for the parameter set θ{p2a*, p2b*} is repeated (inner loop) until it is determined that the third condition is satisfied in the processing of S64.

In a case where the third condition is satisfied (S64; yes), the first determination unit 35A applies the parameter set θ{p2a*, p2b*} updated last in the processing of S63 to the second intensity function calculation unit 33B as θ*{p2a*, p2b*} (S65).

The first monotonic neural network 33B-1a to which the plurality of parameters θ′{p2a*} is applied calculates the outputs f_{b}*(t) and f_{b}*(0) according to a monotonically increasing function defined by the time t (S66a).

In addition, the second monotonic neural network 33B-1b to which the plurality of parameters θ′{p2b*} is applied calculates the outputs g_{b}*(t′), g_{b}*(τ), and g_{b}*(0) according to a monotonically increasing function defined by the time t, the time t′, and the period τ (S66b).

The cumulative intensity function calculation unit 33B-2 calculates the cumulative intensity function Λ_{b}*(t) on the basis of the outputs f_{b}*(t) and f_{b}*(0) calculated in the processing of S66a and the outputs g_{b}*(t′), g_{b}*(τ), and g_{b}*(0) calculated in the processing of S66b (S67).

The automatic differentiation unit 33B-3 calculates the intensity function λ_{b}*(t) on the basis of the cumulative intensity function Λ_{b}*(t) calculated in the processing of S67 (S68).

The predicted sequence generation unit 38 generates the predicted sequence Eq* on the basis of the intensity function λ_{b}*(t) calculated in S68 (S69). Then, the predicted sequence generation unit 38 outputs the predicted sequence Eq* generated in the processing of S69 to the user.

When the processing of S69 ends, the prediction operation in the event prediction apparatus 1 ends (end).

### 2.5 Effects According to Second Embodiment

According to the second embodiment, the first intensity function calculation unit 33A to which the parameter set θ{p2a, p2b} is applied calculates the intensity function λₐ(t) using the time t, the time t′, and the period τ as inputs. The first update unit 34A updates the parameter set θ{p2a, p2b} to the parameter set θ′{p2a, p2b} on the basis of the intensity function λₐ(t) and the support sequence Es. The second intensity function calculation unit 33B to which the parameter set θ′{p2a, p2b} is applied calculates the intensity function λ_{b}(t) using the time t, the time t′, and the period τ as inputs. The second update unit 34B updates the parameter set θ{p2a, p2b} on the basis of λ_{b}(t) and the query sequence Eq. As a result, it is possible to model a point process even in a case where a meta-learning method is used such as MAML.

In this case, the cumulative intensity function calculation unit 33A-2 calculates the cumulative intensity function Λₐ(t) on the basis of the outputs fₐ(t), fₐ(0), gₐ(t′), gₐ(τ), and gₐ(0). The cumulative intensity function calculation unit 33B-2 calculates the cumulative intensity function Λ_{b}(t) on the basis of the outputs f_{b}(t), f_{b}(0), g_{b}(t′), g_{b}(τ), and g_{b}(0). As a result, it is possible to alleviate demand for the expressive power required for the outputs of the first monotonic neural networks 33A-1a and 33B-1. Therefore, effects equivalent to those of the first embodiment can be obtained.

### 3. Third Embodiment

Next, an information processing apparatus according to a third embodiment will be described.

In the third embodiment, a plurality of types of periods τ, for example, τᵢ (i=1 to n), that is, τ₁, τ₂, . . . τₙ are prepared in the first embodiment.

A configuration of an event prediction apparatus according to the third embodiment is similar to that of the first embodiment.

On the other hand, in the third embodiment, the cumulative intensity function calculation unit 24-2 calculates the cumulative intensity function Λ(t) on the basis of the period τᵢ, and outputs fᵢ(z, t), gᵢ(z, t′ᵢ), gᵢ(z, τᵢ), and the like according to Formulas (2) and (3) described above and Formula (8) below.

The terms f(z, t) and f(z, 0) on the right side of Formula (3) related to λᵢ(u) are calculated by the first monotonic neural network 24-1a. The terms gᵢ(z, t′ᵢ), gᵢ(z, τ₁), and gᵢ(z, 0) on the right side of Formula (8) related to λ₂(u) are calculated by the i-th second monotonic neural network 24-1b.

$$[ Math . 4 ]$$

$${\int }_{0}^{t} {λ}_{2} ( u ) du = {\sum }_{i = 1}^{n} [ {g}_{i} ( z , {t}_{i}^{′} ) + ⌊ \frac{t}{{τ}_{i}} ⌋ {g}_{i} ( z , {τ}_{i} ) - ( ⌊ \frac{t}{{τ}_{i}} ⌋ + 1 ) {g}_{i} ( z , 0 ) ] \qquad Formula ( 8 )$$

As indicated in Formulas (2), (3), and (8), the cumulative intensity function Λ(t) includes the outputs f(z, t) and f(z, 0) from the first monotonic neural network S24-1a, and the output gᵢ(z, t′ᵢ) and the like from the i-th second monotonic neural network 24-1b taken into consideration. The cumulative intensity function calculation unit 24-2 transmits the calculated cumulative intensity function Λ(t) to the automatic differentiation unit 24-3.

### 4. Fourth Embodiment

Next, an information processing apparatus according to a fourth embodiment will be described.

In the fourth embodiment, a plurality of types of periods τ, for example, τ₁, τ₂, . . . , τₙ are prepared in the second embodiment.

A configuration of an event prediction apparatus according to the fourth embodiment is similar to that of the second embodiment.

On the other hand, in the fourth embodiment, the cumulative intensity function calculation unit 33A-2 of the first intensity function calculation unit 33A calculates the cumulative intensity function Λₐ(t) on the basis of the period τᵢ, the outputs fₐ(t), gₐ(t′), gₐ(τᵢ), and the like according to the Formulas (5) and (6) described above, and Formula (9) below.

The terms fₐ(t) and fₐ(0) on the right side of Formula (6) related to λₐ₁(u) are calculated by the first monotonic neural network 33A-1a. The terms on the right side of Formula (9) related to λₐ₂(u)

gₐ_{ᵢ}(t*ᵢ) [symbol] gₐ_{ᵢ}(τᵢ) [symbol] and gₐ_{ᵢ}(0) [Math. 5]

are calculated by the second monotonic neural network 33A-1b.

$$[ Math . 6 ]$$

$${\int }_{0}^{t} {λ}_{a 2} ( u ) du = {\sum }_{i = 1}^{n} [ {g}_{{a}_{i}} ( {t}_{i}^{′} ) + ⌊ \frac{t}{{τ}_{i}} ⌋ {g}_{{a}_{i}} ( {τ}_{i} ) - ( ⌊ \frac{t}{{τ}_{i}} ⌋ + 1 ) {g}_{{a}_{i}} ( 0 ) ] \qquad Formula ( 9 )$$

In the fourth embodiment, as indicated in Formulas (5), (6), and (9), the cumulative intensity function Λₐ(t) includes the outputs fₐ(t) and fₐ(0) from the first monotonic neural network 33A-1a, and the outputs

gₐ_{ᵢ}(t′ᵢ) [symbol] gₐ_{ᵢ}(t′ᵢ) [symbol] and gₐ_{ᵢ}(0) [Math. 7]

from the second monotonic neural network 33A-1b taken into consideration. The cumulative intensity function calculation unit 33A-2 transmits the calculated cumulative intensity function Λₐ(t) to the automatic differentiation unit 33A-3.

In addition, the cumulative intensity function calculation unit 33B-2 of the second intensity function calculation unit 33B calculates the cumulative intensity function Λ_{b}(t) on the basis of the period τᵢ, and the outputs f_{b}(t), g_{b}(t′), g_{b}(τᵢ), and the like according to Formulas (5), (6), and (9) described above (where λₐ, fₐ, and gₐ are replaced with λ_{b}, f_{b}, and g_{b}).

The outputs f_{b}(t) and f_{b}(0) are calculated by the first monotonic neural network 33B-1a.

The outputs

g_{b}_{ᵢ}(t*ᵢ) [symbol] g_{b}_{ᵢ}(t*ᵢ) [symbol] and g_{b}_{ᵢ}(0) [Math. 8]

are calculated by the second monotonic neural network 33B-1b.

In the fourth embodiment, the cumulative intensity function Λ_{b}(t) includes the outputs f_{b}(t) and f_{b}(0) from the first monotonic neural network 33B-1a, and the outputs

g_{b}_{ᵢ}(t′ᵢ) [symbol] g_{b}_{ᵢ}(t′ᵢ) [symbol] and g_{b}_{ᵢ}(0) [Math. 9]

from the second monotonic neural network 33B-1b taken into consideration. The cumulative intensity function calculation unit 33B-2 transmits the calculated cumulative intensity function Λ_{b}(t) to the automatic differentiation unit 33B-3.

### 5. Fifth Embodiment

Next, an information processing apparatus according to a fifth embodiment will be described.

In the fifth embodiment, the period τ is a learnable parameter in the first embodiment.

At the time of learning, if a learnable parameter is included in a floor function, a gradient is 0.

In the fifth embodiment, for example, learning is performed, for example, using a known method disclosed in a literature “Edward Wilson, et al., “Backpropagation Learning for Systems with Discrete-Valued Functions”, Proceedings of the World. Congress on Neural Networks, San Diego, California, June 1994, <http://www.intellization.com/files/NN_noisy_backprop_paper_WCNN_94.pdf>”, or the like.

A plurality of types of periods τ may be prepared similarly to the third embodiment, and the plurality of types of periods τ may include both τ obtained by learning and τ arbitrarily given.

### 6. Sixth Embodiment

Next, an information processing apparatus according to a sixth embodiment will be described.

In the sixth embodiment, the period τ is a learnable parameter in the second embodiment.

At the time of learning, if a learnable parameter is included in a floor function, a gradient is 0.

Similarly to the fifth embodiment, in the sixth embodiment, learning is performed using a known method disclosed in “Edward Wilson, “Backpropagation Learning for Systems with Discrete-Valued Functions”, Proceedings of the World Congress on Neural Networks, San Diego, California, June 1994”, or the like.

A plurality of types of periods τ may be prepared similarly to the fourth embodiment, and the plurality of types of periods τ may include both τ obtained by learning and τ arbitrarily given.

### 7. Other Modifications and the Like

Various modifications can be applied to the embodiments described above. In the following modifications, differences from the first embodiment will be described.

### 7.1 First Modification

In the first embodiment described above, a case has been described where each event is not provided with a mark or additional information; however, embodiments are not limited thereto. For example, each event may be provided with a mark or additional information. The mark or additional information provided to each event is, for example, what the user has purchased, a payment method, and the like. Hereinafter, for simplicity, the mark or the additional information is simply referred to as a “mark”.

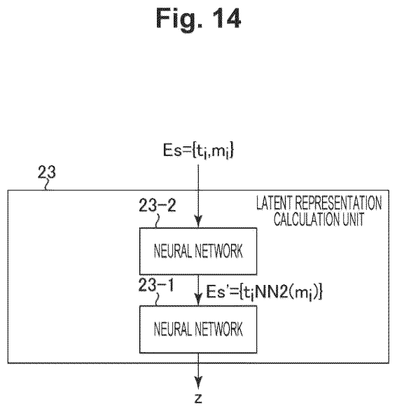

FIG. 14 is a block diagram illustrating an example of a configuration of a latent representation calculation unit of an event prediction apparatus according to a first modification. The latent representation calculation unit 23 further includes a neural network 23-2. In addition, in the example of FIG. 14, the support sequence Es is a sequence of a set of an event occurrence time tᵢ and a mark mi (Es={(tᵢ, mi)}).

The neural network 23-2 is a mathematical model modeled to output a parameter NN2(mᵢ) considering the mark mᵢ using the mark mᵢ as an input. Then, the neural network 23-2 generates a sequence Es′={[tᵢNN2(mᵢ)]} by combining the output NN2(mᵢ) with the event occurrence time tᵢ in the support sequence Es. The neural network 23-2 transmits the generated sequence Es′ to the neural network 23-1.

The neural network 23-1 outputs the latent representation z using the sequence Es′ as an input. The neural network 23-1 transmits the output latent representation z to the intensity function calculation unit 24.

Note that, although not illustrated in FIG. 14, a plurality of parameters is applied to the neural network 23-2. Similarly to the plurality of parameters p1, p2a, and p2b, the plurality of parameters applied to the neural network 23-2 is initialized by the initialization unit 22 and updated by the update unit 25.

With the above configuration, the latent representation calculation unit 23 can calculate the latent representation z while considering the mark mᵢ. As a result, event prediction accuracy can be improved.

### 7.2 Second Modification

In the first embodiment described above, a case has been described where the sequence is not provided with additional information; however, embodiments are not limited thereto. For example, the sequence may be provided with additional information. The additional information provided to the sequence is, for example, attribute information on the user such as gender and age of the user.

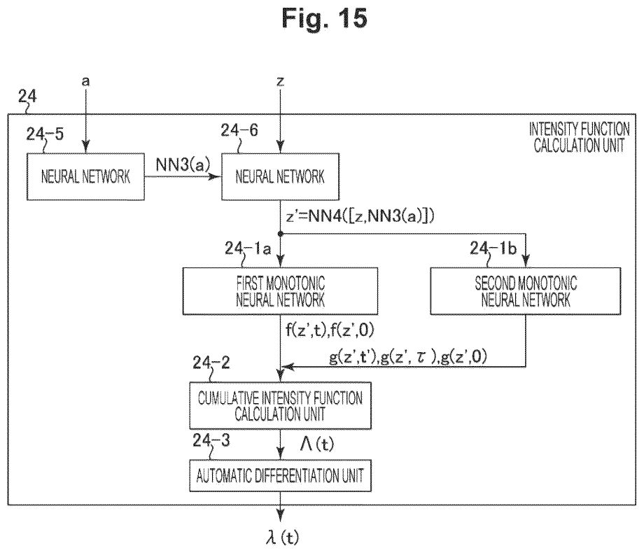

FIG. 15 is a block diagram illustrating an example of a configuration of an intensity function calculation unit of an event prediction apparatus according to a second modification. The intensity function calculation unit 24 further includes neural networks 24-5 and 24-6.

The neural network 24-5 is a mathematical model modeled to output a parameter NN3(a) considering additional information a using the additional information a as an input. The neural network 24-5 transmits the output parameter NN3(a) to the neural network 24-6.

The neural network 24-6 uses the latent representation z and the parameter NN3(a) as inputs, and outputs a latent representation z′=NN4([z, NN3(a)]) considering the additional information a. The neural network 24-6 transmits the output latent representation z′ to the first monotonic neural network 24-1a and the second monotonic neural network 24-1b.

The first monotonic neural network 24-1a calculates outputs f(z′, t) and f(z′, 0) according to a monotonically increasing function defined by the latent representation z′ and the time t. The first monotonic neural network 24-1a transmits the calculated outputs f(z′, t) and f(z′, 0) to the cumulative intensity function calculation unit 24-2.

The second monotonic neural network 24-1b calculates outputs g(z′, t′), g(z′, τ), and g(z′, 0) according to a monotonically increasing function defined by the latent representation z′, the time t, the time t′, and the period τ. The second monotonic neural network 24-1b transmits the calculated outputs g(z′, t′), g(z′, τ), and g(z′, 0) to the cumulative intensity function calculation unit 24-2.

Since configurations of the cumulative intensity function calculation unit 24-2 and the automatic differentiation unit 24-3 are equivalent to those of the first embodiment, description thereof will be omitted. Note that, in the calculation of the cumulative intensity function by the cumulative intensity function calculation unit 24-2, Formulas (2) to (4) described above (where z is replaced with z′) can be used.

Note that, although not illustrated in FIG. 15, a plurality of parameters is applied to the neural networks 24-5 and 24-6. Similarly to the plurality of parameters p1, p2a, and p2b, the plurality of parameters applied to the neural networks 24-5 and 24-6 is initialized by the initialization unit 22 and updated by the update unit 25.

With the above configuration, the intensity function calculation unit 24 can calculate the output f(z′, t) while considering the additional information a. As a result, event prediction accuracy can be improved.

### 7.3 Third Modification

In the second embodiment described above, a case has been described where the sequence Es is not provided with additional information; however, embodiments are not limited thereto. For example, the sequence may be provided with additional information.

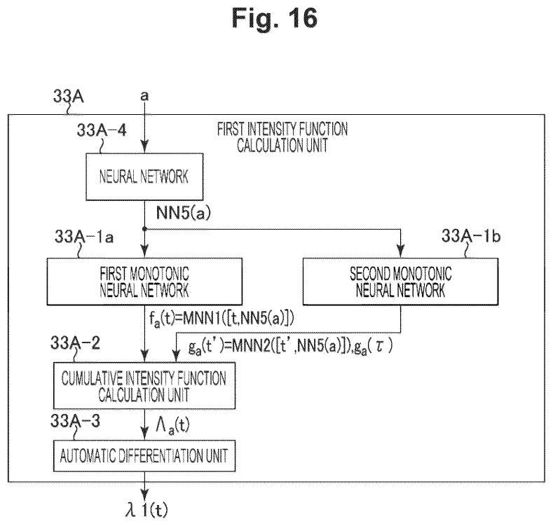

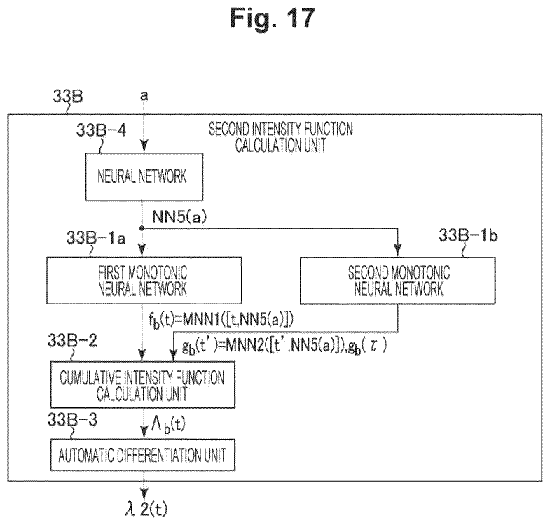

FIG. 16 is a block diagram illustrating an example of a configuration of a first intensity function calculation unit of an event prediction apparatus according to a third modification. FIG. 17 is a block diagram illustrating an example of a configuration of a second intensity function calculation unit of the event prediction apparatus according to the third modification. The first intensity function calculation unit 33A and the second intensity function calculation unit 33B further include neural networks 33A-4 and 33B-4, respectively.

The neural networks 33A-4 and 33B-4 each are a mathematical model modeled to output a parameter NN5(a) considering additional information a using the additional information a as an input. The neural networks 33A-4 and 33B-4 transmit the output parameters NN5(a) to the first monotonic neural networks 33A-1a and 33B-1a and the second monotonic neural networks 33A-1b and 33B-1b, respectively.

The first monotonic neural networks 33A-1a calculates the outputs fₐ(t) and fₐ(0) according to a monotonically increasing function defined by the parameter NN5(a) and the time t. The first monotonic neural networks 33B-1a calculates the outputs f_{b}(t) and f_{b}(0) according to a monotonically increasing function defined by the parameter NN5(a) and the time t. Here, both the outputs fₐ(t) and f_{b}(t) are represented as MNN1([t, NN5(a)]). The first monotonic neural network 33A-1a transmits the calculated output fₐ(t) and fₐ(0) to the cumulative intensity function calculation unit 33A-2. The first monotonic neural network 33B-1a transmits the calculated outputs f_{b}(t) and f_{b}(0) to the cumulative intensity function calculation unit 33B-2.

The second monotonic neural network 33A-1b calculates outputs gₐ(t′), gₐ(τ), and gₐ(0) according to a monotonically increasing function defined by the parameter NN5(a), the time t, the time t′, and the period τ. The second monotonic neural network 33B-1b calculates outputs g_{b}(t′), g_{b}(τ), and g_{b}(0) according to a monotonically increasing function defined by the parameter NN5(a), the time t, the time t′, and the period τ. Here, both the outputs gₐ(t′) and g_{b}(t′), are represented as MNN2([t′, NN5(a)]). The second monotonic neural network 33A-1b transmits the calculated outputs gₐ(t′), gₐ(τ), and gₐ(0) to the cumulative intensity function calculation unit 33A-2. The second monotonic neural network 33B-1b transmits the calculated outputs g_{b}(t′), g_{b}(τ), and g_{b}(0) to the cumulative intensity function calculation unit 33B-2.

Since configurations of the cumulative intensity function calculation units 33A-2 and 33B-2 and the automatic differentiation units 33A-3 and 33B-3 are equivalent to those of the second modification, description thereof will be omitted.

Note that, although not illustrated in FIGS. 16 and 17, a plurality of parameters is applied to the neural networks 33A-4 and 33B-4. Similarly to the parameter set θ{p2a, p2b}, the plurality of parameters applied to the neural network 33A-4 is initialized by the initialization unit 32 and updated by the first update unit 34A. Similarly to the parameter set θ′{p2a, p2b}, the plurality of parameters applied to the neural network 33B-4 is used for update by the second update unit 34B.

With the above configuration, the first intensity function calculation unit 33A can calculate the outputs fₐ(t) and gₐ(t′) while considering the additional information a, and the second intensity function calculation unit 33B can calculate the outputs f_{b}(t) and g_{b}(t′) while considering the additional information a. As a result, event prediction accuracy can be improved.

### 7.4 Others

In the first to sixth embodiments and the first to third modifications described above, a dimension of the event is described as one dimension of time; however, embodiments are not limited thereto. For example, the dimension of the event can be extended to any number of dimensions greater than or equal to two (for example, three dimensions of time and space).

In the first to sixth embodiments and the first to third modifications described above, a case has been described where the learning operation and the prediction operation are executed by the programs stored in the event prediction apparatus 1; however, embodiments are not limited thereto. For example, the learning operation and the prediction operation may be executed using a calculation resource on a cloud.

The information processing apparatus according to each embodiment is not limited to a configuration in which meta-learning of a point process is performed, and can be applied to a configuration in which learning of the point process is performed without using the meta-learning. In addition, the information processing apparatus according to each embodiment can also be applied to, for example, a configuration that solves a regression problem for which monotonicity is desired to be ensured. Examples of the regression problem for which monotonicity is desired to be ensured include a problem of estimating a credit risk from an amount of loan usage. In addition, the information processing apparatus according to each embodiment can also be applied to a configuration that solves a problem in which a neural network that ensures invertible transformation is used. Examples of the problem in which a neural network that ensures invertible transformation is used include empirical distribution density estimation, variational auto-encoders (VAEs), speech synthesis, likelihood-free inference, probabilistic programming, and image generation. In addition, the information processing apparatus according to each embodiment can also be applied to a configuration that solves a problem in which a hazard function of survival analysis is used.

In addition, the method described in each embodiment can be stored as a program (software means) that can be executed by a computing machine (computer), for example, in a recording medium such as a magnetic disk (such as a floppy (registered trademark) disk or a hard disk), an optical disc (such as a CD-ROM, a DVD, or a MO), or a semiconductor memory (such as a ROM, a RAM, or a flash memory), and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present apparatus executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiments include various inventions, and various inventions can be extracted by a combination selected from a plurality of disclosed components. For example, even if some components are deleted from all the components described in the embodiments, a configuration from which the components have been deleted can be extracted as an invention, as long as the problem can be solved and the effects can be achieved.

### REFERENCE SIGNS LIST

1 Event prediction apparatus
10 Control circuit
11 Memory
12 Communication module
13 User interface
14 Drive
15 Storage medium
20, 30, 40, 50 Learning data set
21, 31 Data extraction unit
22, 32 Initialization unit
23 Latent representation calculation unit
23-1, 23-2, 24-4, 24-5, 24-6, 33A-4, 33B-4 Neural network
24 Intensity function calculation unit
24-1a, 33A-1a, 33B-1a First monotonic neural network
24-1b, 33A-1b, 33B-1b Second monotonic neural network
24-2, 33A-2, 33B-2 Cumulative intensity function calculation unit
24-3, 33A-3, 33B-3 Automatic differentiation unit
25 Update unit
25-1, 34A-1, 34B-1 Evaluation function calculation unit
25-2, 34A-2, 34B-2 Optimization unit
26 Determination unit
27, 36 Learned parameter
28, 37 Prediction data
29, 38 Predicted sequence generation unit
33A First intensity function calculation unit
33B Second intensity function calculation unit
34A First update unit
34B Second update unit
35A First determination unit
35B Second determination unit

1. An information processing apparatus comprising:
a first monotonic neural network;
a second monotonic neural network; and
processing circuitry configured to:
calculate a first cumulative function on a basis of an output from the first monotonic neural network and a first parameter; and
calculate a second cumulative function on a basis of an output from the second monotonic neural network, a second parameter, and a period.

2. The information processing apparatus according to claim 1, wherein the processing circuitry is configured to:
calculate a first cumulative intensity function on a basis of an output from the first monotonic neural network and the first parameter, and
calculate a second cumulative intensity function on a basis of an output from the second monotonic neural network, the second parameter, and the period, and
wherein the processing circuitry is further configured to calculate an intensity function regarding a point process on a basis of the calculated first and second cumulative intensity functions.

3. The information processing apparatus according to claim 2, wherein the processing circuitry is further configured to:
update the first and second parameters on a basis of the calculated intensity function regarding the point process regarding the point process.

4. The information processing apparatus according to claim 1, further comprising:
a neural network that outputs the first and second parameters using all events included in a sequence including a plurality of events discretely arranged on a continuous time or a number of the plurality of events included in the sequence as an input.

5. The information processing apparatus according to claim 1, wherein:
the processing circuitry is further configured to initialize a plurality of weights applied to the first and second monotonic neural networks on a basis of a distribution with a positive average.

6. An information processing method, comprising:
outputting a scalar value according to a monotonically increasing function from a first monotonic neural network;
outputting a scalar value according to a monotonically increasing function from a second monotonic neural network;
calculating a first cumulative function on a basis of the scalar value output from the first monotonic neural network and a first parameter; and
calculating a second cumulative function on a basis of the scalar value output from the second monotonic neural network, a second parameter, and a period.

7. The information processing method according to claim 6, wherein:
the calculating the first cumulative function comprises calculating a first cumulative intensity function on a basis of an output from the first monotonic neural network and the first parameter,
the calculating the second cumulative function comprises calculating a second cumulative intensity function on a basis of an output from the second monotonic neural network, the second parameter, and the period, and
the information processing method further comprises:
calculating an intensity function regarding a point process on a basis of the calculated first and second cumulative intensity functions.

8. A non-transitory storage medium storing a program for causing a computer to execute:
outputting a scalar value according to a monotonically increasing function from a first monotonic neural network;
outputting a scalar value according to a monotonically increasing function from a second monotonic neural network;
calculating a first cumulative function on a basis of the scalar value output from the first monotonic neural network and a first parameter; and
calculating a second cumulative function on a basis of the scalar value output from the second monotonic neural network, a second parameter, and a period.
